(19) United States
(12) Patent Application Publication
(10) Pub. No.: US 2026/0079766 A1
(43) Pub. Date: Mar. 19, 2026

(54) Load Balancing

(71) Applicant: MatX Inc., Mountain View, CA (US)

(72) Inventors: Reiner A. Pope, Sunnyvale, CA (US); Mieszko Lis, San Jose, CA (US)

(21) Appl. No.: 19/327,743

(22) Filed: Sep. 12, 2025

Related U.S. Application Data
(60) Provisional application No. 63/694,727, filed on Sep. 13, 2024.

(51) Int. Cl. G06F 9/50

(52) U.S. Cl. CPC G06F 9/5083; G06F 9/5044; G06F 2209/503

(57) ABSTRACT

Aspects of this disclosure relate to load balancing for artificial intelligence (AI) accelerating cores. A control unit may cause the cores to perform computations of a neural network for a first set of tokens. The control unit may measure hardware occupancy of sub-networks of the network in each of the cores for the computations of the first set of tokens. The control unit generates a load distribution based on the measured hardware occupancy. The control unit re-arranges the load distribution to generate a routing plan that determines how a token selected to be processed by one of the sub-networks is routed among the cores. The control unit may route a second set of tokens to the cores according to the routing plan.

### CROSS-REFERENCE TO RELATED APPLICATIONS

This application claims the benefit of U.S. Provisional Ser. No. 63/694,727, filed on Sep. 13, 2024, which is herein incorporated by reference in its entirety.

### FIELD

This disclosure relates to load balancing and specifically to load balancing for processors that accelerate machine learning operations.

### BACKGROUND

The demands of artificial intelligence (AI) applications have underscored the need for specialized computational frameworks tailored to AI-centric tasks. Traditional processors, while adept at executing general-purpose computations, often face significant inefficiencies when confronted with the intricate algorithms and data-intensive workflows intrinsic to AI processing. The advent of AI processors, purposefully designed to expedite AI-related computations, addresses this pressing need for optimized performance and efficiency. These specialized chips integrate innovative architectural features and are tailored explicitly for the unique demands of AI workloads.

Some machine learning models involve dynamically routing activations to different parts of a neural network. Sub-networks of the neural network can be implemented in parallel by different computational devices. However, the performance advantages of this parallelism are reduced in the presence of load imbalances between sub-networks (e.g., one sub-network processing significantly more than another sub-network).

### SUMMARY

This disclosure describes embodiments which can achieve the advantages of parallelism while also reducing or avoiding inefficiencies due to load imbalances between sub-networks. These embodiments may be referred to as load balancing, which may take the form of probability distribution-based load balancing.

In some embodiments, the disclosure relates to a method for balancing workload of a plurality of artificial intelligence (AI) accelerating cores, the AI-accelerating cores being integrated circuits, the method including: causing the plurality of cores to perform computations of a neural network for a first set of tokens, wherein the neural network includes a plurality of sub-networks, and the tokens in the first set are processed by different sub-networks in the neural network; measuring hardware occupancy (e.g., utilization) of the sub-networks in each of the cores for the computations of the first set of tokens; generating a load distribution based on the measured hardware occupancy, the load distribution indicating how the plurality of cores are utilized in the computations of the first set of tokens; re-arranging the load distribution to generate a routing plan, the routing plan determining how a token selected to be processed by one of the sub-networks is routed among the plurality of cores; and routing a second set of tokens (e.g., the second set may be the same or a different size as the first set) to the plurality of cores according to the routing plan, wherein each token in the second set is routed to one or more cores based on the routing plan.

In some embodiments, the disclosure relates to a system including: a plurality of cores, each implemented as integrated circuit for accelerating artificial intelligence (AI) computations; and a control unit for load-balancing the plurality of cores, the control unit configured to: cause the plurality of cores to perform computations of a neural network for a first set of tokens, wherein the neural network includes a plurality of sub-networks, and the tokens in the first set are processed by (e.g., different) sub-networks in the neural network; measure hardware occupancy of the sub-networks in each of the cores for the computations of the first set of tokens; generate a load distribution based on the measured hardware occupancy, the load distribution indicating how the plurality of cores are utilized in the computations of the first set of tokens; re-arrange the load distribution to generate a routing plan, the routing plan determining how a token selected to be processed by one of the sub-networks is routed among the plurality of cores; and route a second set of tokens (e.g., the second set may be the same or a different size as the first set) to the plurality of cores according to the routing plan, wherein each token in the second set is routed to one or more cores based on the routing plan.

In some embodiments, the disclosure described herein relates to a data-center system, including: a plurality of interconnected AI-accelerating cores arranged in one or more server racks; and one or more host central processing units (CPUs) for load-balancing the plurality of AI-accelerating cores, the host CPUs, when executing a set of load-balancing instructions, are caused to perform: causing the plurality of cores to perform computations of a neural network for a first set of tokens, wherein the neural network includes a plurality of sub-networks, and the tokens in the first set are processed by different sub-networks in the neural network; measuring hardware occupancy of the sub-networks in each of the cores for the computations of the first set of tokens; generating a load distribution based on the measured hardware occupancy, the load distribution indicating how the plurality of cores are utilized in the computations of the first set of tokens; re-arranging the load distribution to generate a routing plan, the routing plan determining how a token selected to be processed by one of the sub-networks is routed among the plurality of cores; and routing a second set of tokens to the plurality of cores according to the routing plan, wherein each token in the second set is routed to one or more cores based on the routing plan.

### BRIEF DESCRIPTION OF THE DRAWINGS

FIG. 1A is a block diagram illustrating an example artificial intelligence (AI) accelerating processor, in accordance with some embodiments.

FIG. 1B is a block diagram illustrating an example layout of an AI-accelerating processor, in accordance with some embodiments.

FIG. 2 is a block diagram illustrating components of an example computation tile, in accordance with some embodiments.

FIG. 3A is a block diagram of an example computing device in which an AI-accelerating processor may be installed, in accordance with some embodiments.

FIG. 3B is a block diagram of an example processor rack, in accordance with some embodiments.

FIG. 4A is a conceptual diagram illustrating an example structure of a machine learning model, in accordance with some embodiments.

FIG. 4B is a conceptual diagram of functional blocks of a transformer-based neural network model, in accordance with some embodiments.

FIG. 5 is a flowchart illustrating an example process to execute one or more AI-accelerating processors, in accordance with some embodiments.

FIG. 6A is a conceptual diagram illustrating various examples of collective operations that may be performed by one or more AI-accelerating processors, in accordance with some embodiments.

FIG. 6B is a conceptual diagram illustrating how a matrix multiplication may be performed using a series of reduced scatter and all-gather operations in one or more AI-accelerating processors, in accordance with some embodiments.

FIG. 7A is a diagram of an example expert distribution tree, in accordance with some embodiments.

FIGS. 7B-7C are diagrams of example expert assignment trees, in accordance with some embodiments.

FIG. 7D is a diagram of a example token routing trees, in accordance with some embodiments.

FIG. 7E is a diagram of an example alias table, in accordance with some embodiments.

FIG. 7F is a diagram of another example expert distribution tree, in accordance with some embodiments.

FIGS. 7G-7I are diagrams of example expert assignment trees, in accordance with some embodiments.

FIGS. 8A-8D are diagrams of example trees, in accordance with some embodiments.

FIG. 9 is a flowchart illustrating an example process for balancing workload of a plurality of artificial intelligence (AI) accelerating cores, in accordance with some embodiments.

FIG. 10 is pseudocode for generating an alias table, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example Processor Architecture

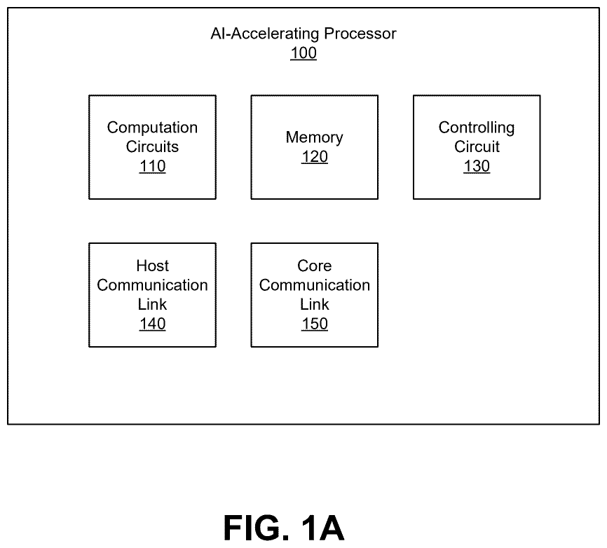

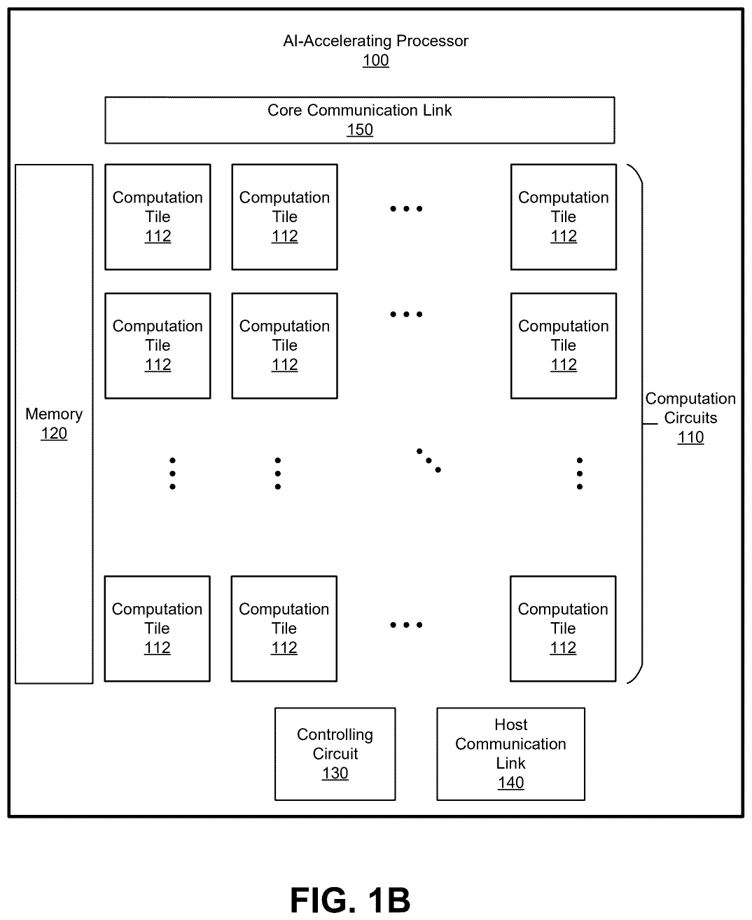

FIG. 1A is a block diagram illustrating an example artificial intelligence (AI) accelerating processor 100, in accordance with some embodiments. An individual AI-accelerating processor 100 is an example of an AI-accelerating processor system. In some cases, multiple AI-accelerating processors 100 may cooperate to form a larger system, such as in the situation of a multi-core system, a system on a chip, or a server rack. Those systems are also examples of an AI-accelerating processor system. An AI-accelerating processor 100 is an integrated circuit such as a processor that is designed to accelerate the execution of various AI models, including in training and making inferences. However, an AI-accelerating processor 100 may also be used to execute other types of computations and programs that are not related to AI, such as in image processing and video processing. In this disclosure, any AI models may be referred to as machine learning models.

In some embodiments, an AI-accelerating processor 100 may include computation circuits 110, memory 120, a controlling circuit 130, a host communication link 140, and a core communication link 150. In various embodiments, an AI-accelerating processor 100 may include additional, fewer, or different components that are not explicitly illustrated in FIG. 1A. While in this disclosure the components in the AI-accelerating processor 100 may at times be described in a singular form, the AI-accelerating processor 100 may include one or more of each of the components. For example, memory 120 may include several units or different memory domains. The core communication link 150 may include multiple communication units. Likewise, components that are described in a plural form may also be present as a single unit in some embodiments.

In some embodiments, computation circuits 110 include integrated circuit such as circuitry that performs computation operations. The computation operations may include various types of computations that are common in machine learning, such as matrix multiplications, multiply-accumulate operations, normalized exponential functions, and other computations, linear or non-linear. Some of the computation operations may take the form of parallel processing, such as in single instruction, multiple data (SIMD), or in multiple instruction, multiple data (MIMD). Computation circuits 110 may include a set of computation units, such as a grid of tiles that performs computations in a parallel fashion. The gird may take the form of a systolic array. A matrix may be divided into sub-matrices and the sub-matrices are distributed among the set of computation units for matrix multiplications. Examples of computation units in the computation circuits 110 may include systolic arrays, arithmetic logic units (ALUs), multiply-add (MAD) circuits, adders, vector processing units, and other specialized circuitry that is used for accelerating certain types of operations, such as softmax operations that are common in machine learning.

Memory 120 is a storage unit that may be used to store data that are used for computations of the computation circuits 110 and store results generated by the AI-accelerating processor 100, whether those results are initial, intermediate, or final. Data fetched via the host communication link 140 or the core communication link 150 may be stored in the memory 120. In some embodiments, an entirety or a portion of a machine learning model may be stored in the memory 120. For example, for a smaller machine learning model, the entirety of the model may be stored in the memory 120. In some embodiments, for a large model such as a large language model (LLM) or another transformer based large model that has billions or even trillions of parameters, the model may be divided into subsets, and the subsets are distributed among memory 120 of a number of AI-accelerating processors 100 that operate cooperatively to perform the calculation. In some embodiments, other types of data, such as training data, learned parameter values, and inference results may also be stored in the memory 120.

In some embodiments, memory 120 may take the form of design high bandwidth memory (HBM), dynamic random access memory (DRAM), including various variations of DRAM, such as synchronous DRAM (SDRAM), double data rate (DDR) SDRAM, other types of DRAM. While DRAM is often considered off-chip memory, in some embodiments'physical layouts, memory 120 may be physically located within the boundary of the AI-accelerating processor 100, such as within the same processor packaging. In some embodiments, memory 120 may also take the form of caches of various levels. In some embodiments, an AI-accelerating processor 100 may include various types of memory. For example, the AI-accelerating processor 100 may include HBM that may be considered off-chip memory, various levels of caches in different components of the AI-accelerating processor 100, and registers that are in the circuitry. For example, an HBM may be co-packaged with the AI-accelerating processor 100 using advanced packaging in which both the HBM stack and the AI-accelerating processor 100 are packaged on a silicon interposer. In some embodiments, the entire package may also be referred to collectively as the AI-accelerating processor 100.

In some embodiments, a controlling circuit 130 is an on-chip controller that manages the overall operation or part of the operation of the AI-accelerating processor 100. The controlling circuit 130 may provide instruction streams, manage register allocation, and determine instruction scheduling. The controlling circuit 130 may generate instructions that are broadcasted to various computation circuits 110, such as in a SIMD or MIMD fashion. In some embodiments, the controlling circuit 130 is not responsible for the entirety of the operation of the AI-accelerating processor 100. For example, the determination of various task-related decisions, such as scheduling, parallelism, load balancing, memory, and register allocation, may be distributed among the controlling circuit 130, a host central processing unit (CPU) (not shown in FIG. 1A), compiler instructions and higher level software instructions.

In some embodiments, the AI-accelerating processor 100 is designed to provide a high degree of flexibility to the software engineers in making task decisions and parallelism decisions. In those embodiments, the controlling circuit 130 may handle a limited number of decisions, such as managing registers in the AI-accelerating processor 100 and scheduling certain computation instructions that are not specified by the software instructions. The rest of the instructions and decisions may be customizable by software engineers at the software code level. In other embodiments, the controlling circuit 130 may generate more task-related commands automatically.

In some embodiments, a host communication link 140 includes integrated circuit such as circuitry for the exchange of data between a host CPU (not shown in FIG. 1A) and the AI-accelerating processor 100. The host CPU may generate system-level instructions that are sent to a set of AI-accelerating processors 100. Each of the AI-accelerating processors 100 may receive those instructions and data from the host CPU via the host communication link 140. The host CPU may also perform long-range communications such as fetching training data from a Cloud data store and performing network communications within a data center network. In some embodiments, the host communication link 140 may take the form of a peripheral component interconnect express (PCIe), another suitable serial bus, or another suitable brand specific communication link or switch, such as NVLink, cache coherent interconnect for accelerators (CCIX), inter-chip global memory interconnect (xGMI), etc.

In some embodiments, a core communication link 150 includes integrated circuit such as circuitry for the exchange of data among different AI-accelerating processors 100 in a multi-core system such as in a processor rack that includes a number of AI-accelerating processors 100 cooperatively performing calculations. The core communication link 150 is processor interconnect link that enables chip-to-chip communication. In some embodiments, the core communication links 150 in a multi-core system allow a particular AI-accelerating processor 100 to communicate with another AI-accelerating processor 100 that is connected by the core communication link 150. In some embodiments, the core communication link 150 may take the form of a communication bus that allows any AI-accelerating processor 100 to communicate with any other AI-accelerating processors 100 in the multi-core system. For example, the core communication link 150 may take the form of a peripheral component interconnect express (PCIe), another suitable serial bus, or another suitable serial bus, or or another suitable brand specific communication link or switch, such as NVLink, cache coherent interconnect for accelerators (CCIX), inter-chip global memory interconnect (xGMI), etc. The core communication link 150 may also be custom communication link designed for the high speed communications among AI-accelerating processors 100 in a computing cluster or a computing node. In some embodiments, the core communication link 150 may also takes the form of optical communication link such as optical interconnects, silicon photonics, co-packaged optics, optical PCIe, etc. In some embodiments, the core communication link 150 may be a custom designed link. In some embodiments, the core communication link 150 may also perform other communication functions such as routing, multiplexing, load balancing, and other flow control tasks.

### Example Chip Component Layout

FIG. 1B is a block diagram illustrating an example layout of an AI-accelerating processor 100, in accordance with some embodiments. Similar to the example AI-accelerating processor 100 in FIG. 1A, the AI-accelerating processor 100 in FIG. 1B includes computation circuits 110, memory 120, a controlling circuit 130, a host communication link 140, and a core communication link 150. The computation circuits 110 may take the form of a grid of computation tiles 112 that cooperate to perform computations.

The components in the AI-accelerating processor 100 may be arranged in any suitable layout that increases the efficiency of data movement to reduce the chance of occurrence of memory-bound computations. For example, in some embodiments, the memory 120 may occupy one or more sides of the periphery of the grid of computation tiles 112 so that each computation tile 112 may fetch data from or store data in memory 120. Data stored in the memory 120 may be individually fetched (e.g., a subset of a matrix) to a particular computation tile 112 or broadcasted or scattered simultaneously to a number of computation tiles 112. The core communication link 150 may occupy another side (or one or more sides) of the periphery of the grid of computation tiles 112 so that the computation tiles 112 may communicate to other computation tiles 112 in other AI-accelerating processors 100 via the core communication link 150. The memory 120 and the core communication link 150 may be located on different sides that are orthogonal to each other. The controlling circuit 130 and the host communication link 140 may occupy relatively smaller silicon landscapes and may be located at any suitable location in the AI-accelerating processor 100.

In some embodiments, the computation circuits 110 include a number of computation tiles 112 that are arranged in rows and columns to form a grid. In this disclosure, various directional terms, such as rows and columns, are merely used to signify a first direction and a second direction that may or may not be orthogonal to each other. Those terms do not always imply particular orientations. For example, a row does not always imply a lateral direction and a column does not always imply a longitudinal direction. Each computation tile 112 may be a computation circuit 110 for performing computation. The formation of a grid allows the computation tiles 112 to work individually for a smaller dataset or in a combined fashion to handle a larger dataset. In some embodiments, the grid may form a systolic array and the grid may be referred to as a systolic array.

In some embodiments, depending on the mode of operation of the AI-accelerating processor 100, the grid of computation tiles 112 may be combined to form a large single computation unit in which individual computation tiles 112 may operate in lockstep with respect to each other. For example, each computation tile 112 may handle a particular data size per time step (e.g., 8×8, 16×16, 32×32 64×64, 128×128, 256×256 elements, etc.) while the combination of the grid of computation tiles 112 may be used to handle a much larger data size, such as (512×512, 1024×1024, 2048×2048, 4096×4096 elements, etc.). By way of example, the grid of computation tiles 112 may handle matrix multiplication that involves large matrices of thousands of elements by thousands of elements. A large matrix may be divided into subsets and each subset is fetched to a particular computation tile 112. As such, the data values in the matrix may be distributed among the computation tiles 112 in the grid by splitting the matrix to match the geometry of the grid. For example, if the computation tiles 112 form a grid of 1024 by 1024 elements, an entirety of a matrix with 1024×1024 elements may be stored in the grid and processed.

In some embodiments, the grid of computation tiles 112 may form a systolic array of a very large set of processing elements, each of which includes integrated circuit such as circuitry that is configured to perform certain predefined operations, such as multiplication, addition, accumulation, etc. In some embodiments, each computation tile 112 may include one or more smaller systolic arrays with processing elements, such as 8×8, 16×16, 32×32, 64×64, 128×128, 256×256, 512×512, etc. processing elements. In turn, the grid may include a number of computation tiles 112 so that the grid of computation tiles 112 can be combined to form a large systolic array that may be in the magnitude of 512×512, 1024×1024, 2048×2048, 4096×4096, 8192×8192, etc. processing elements. For a given time step, each processing element may be used to perform the computation of a data value.

While the numerical examples provided here are in the multiples of binary values, the actual size of a systolic array in a computation tile and the combined size of the grid do not always need to follow any numerical patterns. Also, each systolic array does not need to be square and can be rectangular.

The silicon allocation on a large systolic array accelerates the computation of large matrix multiplication. The complexity of matrix multiplication is approximately O(n³) while the complexity of other operations such as memory fetch often grows at a pace of O(n²).

In some embodiments, instead of forming a single grid, the computation tiles 112 may also work in groups or individually to form various subunits of suitable sizes for the computation of datasets that are in various sizes. In some embodiments, the grouping or division of the computation tiles 112 may be controlled by the controlling circuit 130 or on the software level. In some embodiments, the controlling circuit 130 may generate instructions that are broadcasted to one or more computation tiles 112.

In some embodiments, computations, such as matrix multiplication, performed by the grid of computation tiles 112 may be carried out through a series of collective operations, such as broadcast, reduce, scatter, and gather. By way of example, in a matrix multiplication, a left matrix is multiplied by a right matrix. In some embodiments, the left matrix may be divided into subsets. The subsets may be distributed among the computation tiles 112 in the grid by splitting the left matrix to match the geometry of the grid. The multiplication may then be started using a series of collective operation instructions. For example, a matrix multiplication can be broken down into a series of repeated reduce-scatter operation followed by all-gather operation. To perform the matrix multiplication, a right matrix may be divided as column vectors. Each computation tile 112 performs multiplications between the data values of the left matrix and the data values of the column vector of the right matrix. In turn, an all-gather operation is sent to the computation tiles 112 so that each multiplied values are gathered to the appropriate memory locations. After the all-gather operation, another round of reduce-scatter operation and all-gather operation may be performed.

While matrix multiplication is used as an example to illustrate the computation operations of the systolic array, the systolic arrays in the computation tiles 112 may be used to perform computations other than matrix multiplication. Also, each computation tile 112 may include other circuitry in addition to or alternative to systolic arrays. For example, the computation tiles 112 may include other computation circuits that are used for vector manipulation, softmax calculation, and other suitable circuits.

### Example Computation Tile

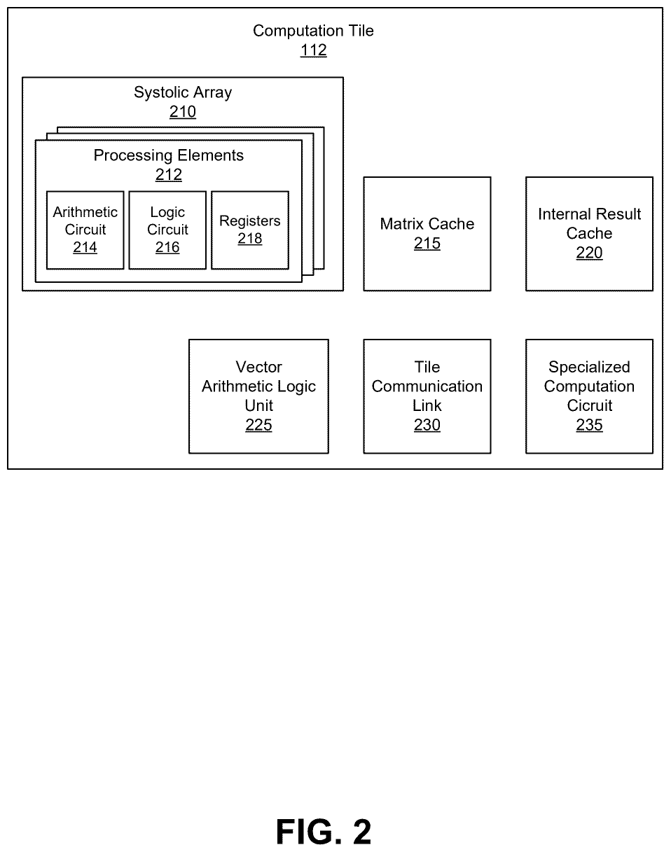

FIG. 2 is a block diagram illustrating components of an example computation tile 112, in accordance with some embodiments. In some embodiments, a computation tile 112 may include systolic arrays 210, a matrix cache 215, an internal result cache 220, a vector arithmetic logic unit (ALU) 225, a tile communication link 230, and a specialized computation circuit 235. In some embodiments, a computation tile 112 may include additional, fewer, or different components that are not explicitly illustrated in FIG. 2.

In some embodiments, a computation tile 112 includes one or more systolic arrays 210, each of which may include a number of processing elements 212. A processing element 212 is a circuit that is configured to perform various computations such as multiplication, addition, accumulation, division, bitwise operation, etc. Data flows through the systolic array in a synchronized manner, with each processing element 212 operating to compute a portion of a larger dataset (e.g., a larger matrix) concurrently. Inputs may be fed into a systolic array 210 from one side, processed as the data propagates through the array, and the results may be accumulated in one or more registers in the systolic array 210. Each processing element 212 in a systolic array 210 may be pipelined. A processing element 212 may include an arithmetic circuit 214, such as an arithmetic logic unit (ALU), to perform arithmetic operations, a logic circuit 216 for bit operations, and registers 218 for storing intermediate data values and partial results. A systolic array 210 may include additional data storage circuits (e.g., registers) to store values that are outputted by the processing elements 212, such as data values that are accumulated from outputs of a set of processing units 212. The additional data storage circuits may be the internal result cache 220.

In some embodiments, each processing element 212 in a systolic array 210 may be configured to perform the computation of a value in a dataset (e.g., a matrix). To reduce the size of a particular processing element 212 to allow an AI-accelerating processor 100 to include more processing elements 212, each processing element 212 may be configured to be limited in precision. In some embodiments, a processing element 212 has integrated circuit such as circuitry that limits the precision of the value being processed to 32 bits, such as in single-precision floating point 32, FP32, or a custom 32-bit format. In some embodiments, a processing element 212 has integrated circuit such as circuitry that limits the precision of the value being processed to 16 bits, such as in FP16 or a custom 16-bit format. In some embodiments, a processing element 212 has integrated circuit such as circuitry that limits the precision of the value being processed to be 8 bits, such as in FP8 or a custom 8-bit format. In some embodiments, a processing element 212 has integrated circuit such as circuitry that limits the precision of the value being processed to be 4 bits, such as in FP4 or a custom 4-bit format.

In some embodiments, a majority or all of the processing elements 212 in a systolic array 210 of a computation tile 112 have integrated circuit such as circuitry that is limited to a low-precision computation. For example, in some embodiments, a majority or all of the processing elements 212 in a systolic array 210 of a computation tile 112 are limited to processing 8-bit precision level. In some embodiments, a majority or all of the processing elements 212 in a systolic array 210 of a computation tile 112 are limited to processing at a 4-bit precision level. To reduce the size of a processing element 212, the arithmetic circuit 214, logic circuit 216, and registers 218 are limited to a low precision level. For example, the adder and multiplier circuits in the arithmetic circuit 214 may only include integrated circuit such as circuitry for 8-bit computation or integrated circuit such as circuitry for 4-bit computation. The registers 218 may also be limited to storing 4-bit values or 8-bit values. The reduction of precision level improves the computation speed and power consumption of an AI-accelerating processor 100.

In some embodiments, by limiting the precision level of integrated circuit such as circuitry in the computation tiles 112, such as limiting the components in the systolic array 210, the internal result cache 220, and specialized computation circuit 235, the area occupied by a computation tile 112 is significantly reduced compared to a conventional processor with a different architecture. As such, using a limited precision level to reduce the size of an individual processing unit 212 allows the AI-accelerating processor 100 to include a systolic array that has a much larger number of processing units 212 compared to a conventional processor. In some embodiments, as discussed in FIG. 1B, the grid of computation tiles 112, in total, may include more than 1000×1000 processing units 212. In some embodiments, the grid of computation tiles 112 may include more than 2000×2000 processing units 212. In some embodiments, the grid of computation tiles 112 may include more than 3000×3000 processing units 212. In some embodiments, the grid of computation tiles 112 may include more than 4000×4000 processing units 212. In some embodiments, the grid of computation tiles 112 may include more than 5000×5000 processing units 212. In some embodiments, the grid of computation tiles 112 may include more than 8000×8000 processing units 212. In some embodiments, the grid of computation tiles 112 may include more than 10,000×10,000 processing units 212.

While in some embodiments a processing unit 212 is limited in precision on the hardware level, an AI-accelerating processor 100 may continue to support higher precision computation by breaking down computations of a higher precision value. For example, in an embodiment where a processing element 212 is limited to 4 bits, a bit 8 computation may be performed by breaking down an 8-bit value into two sets of bits, most significant bits (MSB) and least significant bits (LSB). Multiplication may be performed through a series of computations between MSB and MSB, MSB and LSB, LSB and MSB, and LSB and LSB. Similar computations may be performed for any higher precision values with a lower precision processing element 212.

A computation tile 112 may also include a matrix cache 215, which is memory internal to the computation tiles 112 to store values of a matrix or a portion of a matrix sent to a computation tile 112. As discussed in FIG. 1B, a large matrix may be split and subsets of the matrix may be distributed among a set of computation tiles 112. A subset of the matrix may be sent to a particular computation tile 112 and the values in the subset may be stored in the matrix cache 215. Each value in the subset may be sent to an individual processing element 212 for computation and the results of a set of processing elements 212 may be returned to the cache for accumulation, such as the matrix cache 215 or internal result cache 220. Intermediate results of matrix computation may also be stored in the matrix cache 215 or internal result cache 220.

In some embodiments, a computation tile 112 may include different types of caches that are configured to efficiently store different types of data. For example, in addition to or alternative to the matrix cache 215, a computation tile 112 may include an internal result cache 220 that is used to store internal results and vectors that are fetched to the computation tile 112. For example, in matrix multiplication, a column vector of a right matrix may be broadcasted or scattered to a computation tile 112 and may be stored in the internal result cache 220. Since the dimension of a column vector, which is an array of numbers, is often different from the dimension of a subset of the matrix, the internal result cache 220 may be sized and dimensioned differently from the matrix cache 215 to increase the efficiency of the storage.

The internal result cache 220 may also be used to store other types of data such as intermediate values and other temporary vectors.

In some embodiments, in addition to the ALUs in the processing element 212, a computation tile 112 may also include another ALU circuit that is used for vector computation and manipulation, such as the vector ALU 225. The vector ALU 225 may be used for vector manipulation, such as vector multiplication, transpose, and comparison between two vectors, dot products, etc. The vectors may include a column vector of a matrix in matrix multiplication and other vectors that are involved in the computation.

In some embodiments, a computation tile 112 includes a tile communication link 230. A computation tile 112 may be part of a grid of computation tiles 112 as illustrated in FIG. 1B. Values from outputs of different computation tiles 112 may be collected (e.g., accumulated or gathered) on the chip level. The tile communication link 230 allows a computation tile 112 to communicate with one or more other computation tiles 112 in the grid. Computation tiles 112 may work with each other in different manners. For example, in one mode of operation of the grid, a set of computation tiles 112 may serve as units in parallel processing to process a large dataset's values that are distributed among the set of computation tiles 112. In another mode of operation, a computation tile 112 may serve as a computation unit downstream or upstream of another computation tile 112. The tile communication link 230 may be configured to transmit values between the computation tiles 112. A tile communication link 230 may take the form of direct wires between two or more computation tiles 112 or a communication component that is used for cross-tile communication.

In some embodiments, a computation tile 112 may also include a specialized computation circuit 235. A specialized computation circuit 235 may include computation-specific integrated circuit such as circuitry to accelerate the speed of computation of certain types of computations, such as specific linear or non-linear operations, bitwise operations, softmax operations, or other operations that may be typically inefficient to perform using the systolic array 210 or the vector ALU 225. In some embodiments, a specialized computation circuit 235 includes integrated circuit such as circuitry that is configured to perform softmax operations efficiently.

### Computing Device Architecture

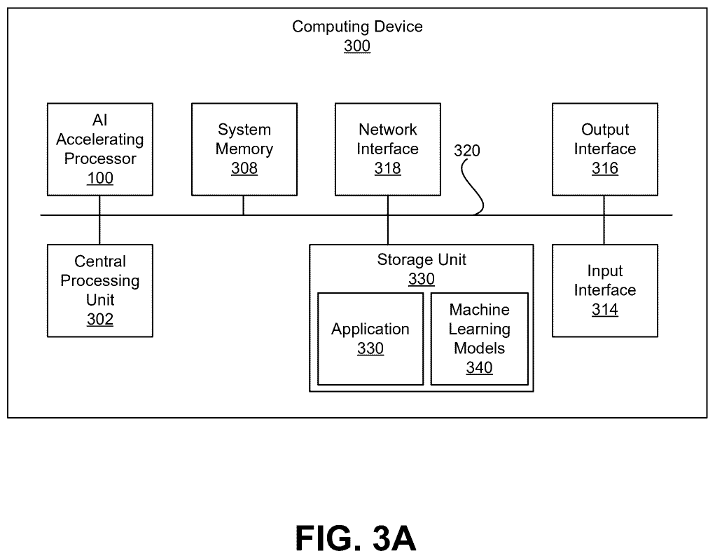

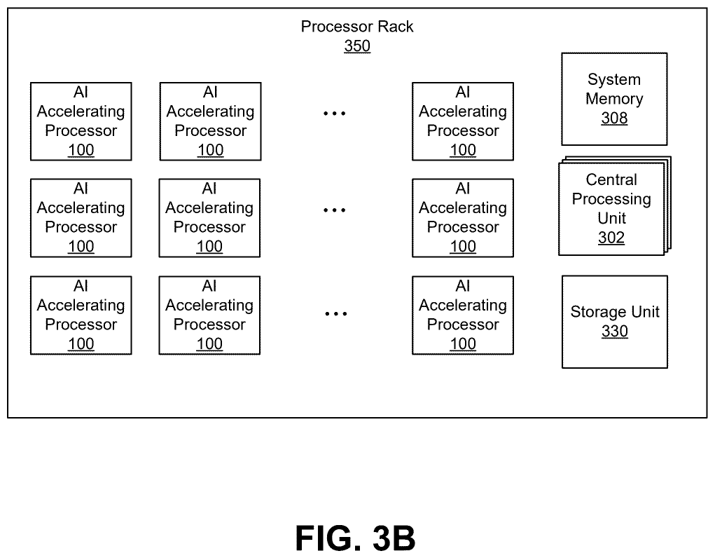

FIG. 3A is a block diagram of an example computing device 300 in which an AI-accelerating processor 100 may be installed, in accordance with some embodiments. A computing device 300 may be a server computer, a personal computer, a portable electronic device, a wearable electronic device (e.g., a smartwatch), an IoT device (e.g., a sensor), a smart/connected appliance (e.g., a refrigerator), a device in edge computing, a robot such as a general or specific purpose humanoid, a vehicle such as an electric vehicle or an autonomous vehicle, etc. The computing device 300 may include, among other components, a central processing unit (CPU) 302, an AI-accelerating processor 100, system memory 308, a storage unit 310, an input interface 314, an output interface 316, a network interface 318, and a bus 320 connecting these components. In various embodiments, computing device 300 may include additional, fewer, or different components.

CPU 302 may be a general-purpose processor using any appropriate architecture and may be referred to as a host processor. CPU 302 retrieves and executes computer code that includes instructions, when executed, that may cause CPU 302 or another processor, individually or in combination, to perform certain actions or processes that are described in this disclosure. Instructions may be stored in different forms, such as machine-readable instructions, programming instructions including source code, and other communication signals and orders. The term “instructions” may be used in a general sense and is not limited to machine-readable codes. CPU 302 may be used to compile the instructions and also determine which processors may be used to perform certain tasks based on the commands in the instructions. For example, certain machine learning computations may be more efficient to be processed using AI-accelerating processor 100 while other computations may be better to be processed using a general processor.

An AI-accelerating processor 100 may be a processor that is efficient at performing certain machine learning operations such as matrix multiplications, convolutions, dot products, etc. In various embodiments, an AI-accelerating processor 100 may have different hardware architectures. For example, in some embodiments, an AI-accelerating processor 100 may include any of the architecture or component features that are described in FIG. 1A through FIG. 2 or anywhere else in this disclosure. The AI-accelerating processor 100 may also serve as a graphics processing unit (GPU).

While in FIG. 3A, the processors CPU 302 and AI-accelerating processor 100 are illustrated as separated components, in various embodiments the structure of one processor may be embedded in another processor. For example, one or more examples of the integrated circuit such as circuitry of AI-accelerating processor 100 disclosed in different figures of this disclosure may be embedded in a CPU 302. The processors may also be included in a single system such as in a system-on-a-chip (SoC) implementation. In various embodiments, computing device 300 may also include additional processors, such as a GPU, for various specific purposes. In this disclosure, the various processors may be collectively referred to as “processors” or a “processor.”

The system memory 308 includes integrated circuit such as circuitry for storing instructions for execution by a processor and for storing data processed by the processor. System memory 380 may take the form of any type of memory structure including, for example, high bandwidth memory (HBM), dynamic random access memory (DRAM), synchronous DRAM (SDRAM), double data rate (DDR, DDR2, DDR3, etc.), static RAM (SRAM), or a combination thereof. System memory 308 usually takes the form of volatile memory. In some embodiments, the system memory 308 may serve as memory for the CPUs 302. While an AI-accelerating processor 100 can have access to the system memory 308, the AI-accelerating processor 100 may include its own off-chip memory such as HBM in memory 120 illustrated in FIG. 1B.

Storage unit 310 may be a persistent storage for storing data and software applications in a non-volatile manner. Storage unit 310 may take the form of read-only memory (ROM), hard drive, flash memory, or another type of non-volatile memory device. Storage unit 310 stores the operating system of the computing device 300, various software applications 330, and machine learning models 340. The storage unit 310 may store computer code that includes instructions that, when executed, cause a processor to perform one or more processes described in this disclosure. In some embodiments, a machine learning model may be stored in the storage unit 310 or system memory 308.

Applications 330 may be any suitable software applications that operate on the computing device 300. An application 330 may be in communication with other devices via network interface 318. Applications 330 may be of different types. In one case, an application 330 may be a web application, such as an application that runs on JavaScript. In another case, an application 330 may be a mobile application. For example, the mobile application may run on Swift for iOS and other APPLE operating systems or on Java or another suitable language for ANDROID systems. In yet another case, an application 330 may be a software program that operates on a desktop operating system such as LINUX, MICROSOFT WINDOWS, MAC OS, or CHROME OS. In yet another case, an application 330 may be a built-in application in an IoT device. An application 330 may include a graphical user interface (GUI) that visually renders data and information. An application 330 may include tools for training machine learning models 340 and/or making inferences using a trained machine learning models 340.

Machine learning models 340 may include different types of algorithms for making inferences based on the training of the models. Examples of machine learning models 340 include regression models, random forest models, support vector machines (SVMs) such as kernel SVMs, artificial neural networks (ANNs) such as convolutional network networks (CNNs), recurrent network networks (RNNs), autoencoders, long short term memory (LSTM), reinforcement learning (RL) models, transformer models, large language models (LLMs), generative pre-trained transformers (GPT), other transformer based large models, and other generative models. In various embodiments, a machine learning model 340 may be in different forms. For example, a machine learning model 340 may be an independent model. A machine learning model 340 may also be part of a software application 330.

Input interface 314 receives data from external sources such as sensor data or action information. Output interface 316 is a component for providing the result of computations in various forms (e.g., text, data, image, or audio signals). Computing device 300 may include various types of input or output interfaces, such as displays, keyboards, cameras, microphones, speakers, antennas, fingerprint sensors, touch sensors, and other measurement sensors. Some input interface 314 may directly work with a machine learning model 340 to perform various functions. For example, a sensor may use a machine learning model 340 to infer interpretations of measurements. Output interface 316 may be in communication with humans, robotic agents, or other computing devices.

The network interface 318 enables the computing device 300 to communicate with other computing devices via a network. The networks may include, but are not limited to, Local Area Networks (LANs) (e.g., an Ethernet or corporate network) and Wide Area Networks (WANs). The network interface 318 allows the computing device 300 to generate outputs of a machine learning model 340 and provide the outputs to other remote devices. The computing device 300 may also receive data from remote devices to run a machine learning model 340. For example, the computing device 300 may receive training data from a Cloud server to perform training of the end user device 340 using the AI-accelerating processor 100. The network communication may be controlled by the CPU 302. In some embodiments, the computing device 300 may be part of a data center network. The network interface 318 allows the computing device 300 to perform communication in a data center network.

FIG. 3B is a block diagram of an example of a processor system, such as a processor rack 350, in accordance with some embodiments. The processor rack 350 may also be referred to as a computing cluster or accelerating computing node. The processor rack 350 is an example of a computing device 300. A processor rack 350 may take the form of a rack of chips that include a large number of AI-accelerating processors 100 and additional host processors such as CPUs 302. In a typical arrangement, a processor rack 350 may include 64 AI-accelerating processors 100 and 8 CPUs 302, although the actual number of each type of processor may vary in different embodiments. A processor rack 350 may be implemented in a data center, as a server, or in any suitable setting. In some embodiments, a data center may include a stack of processor racks 350 to perform a large number of computations related to AI. A processor rack 350 may include system memory 308, data store 330, and other components illustrated in FIG. 3A.

The AI-accelerating processors 100 in a processor rack 350 may cooperate to perform computations for a large machine learning model, such as an LLM that has billions or trillions of parameters. In some embodiments, a large machine learning model is divided into subparts, and each subpart is stored in the memory 120 of an AI-accelerating processor 100. In some embodiments, the entirety of a large machine learning model is distributively stored in the memory 120 of AI-accelerating processors 100 in one or more processor racks 350. Each AI-accelerating processor 100 performs computation with respect to a subpart of the large machine learning model and the set of AI-accelerating processors 100 cooperatively generate the overall result of the computation. The CPUs 302 may provide control commands and coordination among the AI-accelerating processors 100.

In some embodiments, to facilitate the communication between the AI-accelerating processors 100, an AI-accelerating processor 100 is connected to one or more other AI-accelerating processors 100 in a switchless manner. An AI-accelerating processor 100 may be connected to one or more other AI-accelerating processors 100 in the processor rack 350 or to every one of the AI-accelerating processors 100 in the processor rack 350. In some embodiments, the processor rack 350 may support a global all-reduce command that causes the processor rack 350 to accumulate the matrix multiplication results from a set of AI-accelerating processors 100. The accumulation and other cross-chip operations may be performed among any number of AI-accelerating processors 100 in the processor rack 350. The communication among the AI-accelerating processors 100 may be conducted via the core communication links 150.

### Example Model Structure

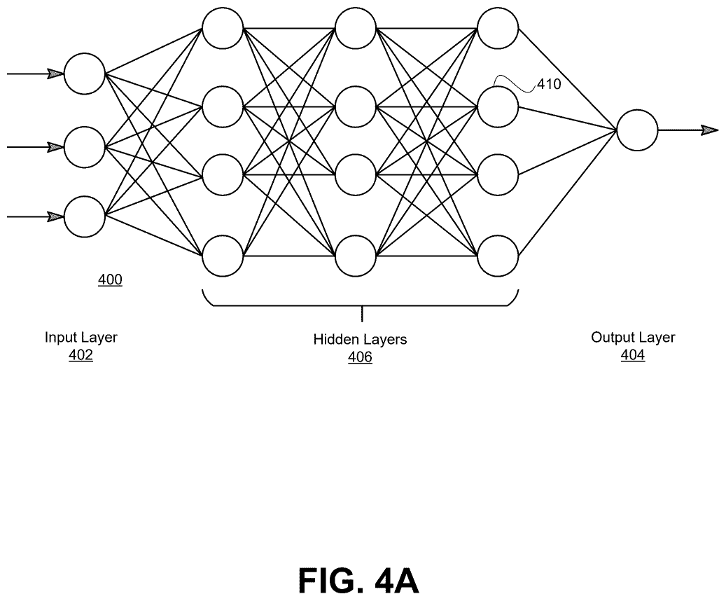

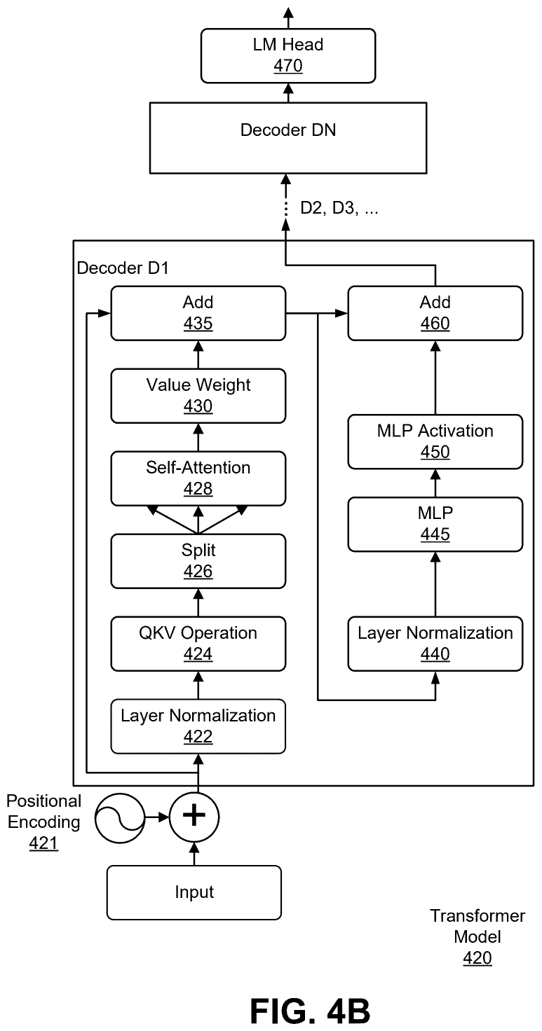

FIG. 4A is a conceptual diagram illustrating an example structure of a machine learning model 400, in accordance with some embodiments. The illustrated machine learning model 400 shows a generic structure of a neural network. The machine learning model 400 is an example of machine learning model 340 that can be stored in a computing device 300 or in one or more AI-accelerating processors 100.

Using a neural network as an example, a machine learning model 400 may include an input layer 402, an output layer 404, and one or more hidden layers 406. Input layer 402 is the first layer of machine learning model 400. Input layer 402 receives input data, such as image data, speech data, text, or an output data from an upstream component. Output layer 404 is the last layer of machine learning model 400. Output layer 404 may generate one or more outputs in the form of classifications or probabilities. Machine learning model 400 may include any number of hidden layers 406. Hidden layer 406 are intermediate layers in machine learning model 400 that perform various operations. Machine learning model 400 may include additional or fewer layers than the example shown in FIG. 4A. Each layer may include one or more nodes 410. The number of nodes in each layer in the machine learning model 400 shown in FIG. 4A is an example only. A node 410 may take a different structure and may be associated with certain weights and activation functions. For example, a node 410 in a transformer model may be an encoder, a decoder, etc. Examples of activation functions may include a step function, a sigmoid function, a hyperbolic tangent function (tanh), rectified linear unit functions (ReLU), softmax, etc. In various embodiments, the nodes 410 in machine learning model 400 may be fully connected or partially connected.

Each node 410 in machine learning model 400 may be associated with different operations. For example, in a simple form, machine learning model 400 may be a neural network whose nodes are each associated with a set of weight coefficients and an activation function. In some embodiments, a machine learning model 400 may be an example of a convolutional neural network (CNN). In this example, CNN, nodes 410 in one layer may be associated with convolution operations with kernels as weights that are adjustable in the training process. Nodes 410 in another layer may be associated with spatial pooling operations. In some embodiments, a machine learning model 400 may be a recurrent neural network (RNN) whose nodes may be associated with more complicated structures such as loops and gates. In some embodiments, a machine learning model 400 may be a transformer model whose nodes may be associated with decoder structure and attention mechanisms. Further detail of a transformer model is discussed in FIG. 4B.

In various embodiments, a wide variety of machine learning techniques may be used in training machine learning model 400. Machine learning model 400 may be associated with an objective function (also commonly referred to as a loss function), which generates a metric value that describes the objective goal of the training process. The training may intend to reduce the error rate of the model in generating predictions. In such a case, the objective function may monitor the error rate of machine learning model 400.

Each of the functions in a machine learning model 400 may be associated with different weights (e.g., coefficients, kernels, activation function coefficients) that are adjustable during training. Training of machine learning model 400 may include forward propagation and backpropagation. In forward propagation, machine learning model 400 performs the computation in the forward direction based on the outputs of a preceding layer. The operation of a node 410 may be defined by one or more functions, such as linear operations and non-linear operations. After an input is provided to machine learning model 400 and passes through machine learning model 400 in the forward direction, the results may be compared to the training labels or other values in the training set to determine the neural network's performance. The forward propagation may be repeated for other samples in the training sets to compute the overall value of the objective function in a particular training round. Gradients may be computed among the nodes 410 in the machine learning model. In turn, machine learning model 400 performs backpropagation by using gradient descent such as stochastic gradient descent (SGD) to adjust the coefficients in various functions to improve the value of the objective function. In some embodiments, one or more AI-accelerating processors 100 may be used to determine the average gradients, which may be determined using operations such as all reduce.

Multiple rounds of forward propagation and backpropagation may be performed. Training may be completed when the objective function has become sufficiently stable (e.g., machine learning model 400 has converged) or after a predetermined number of rounds for a particular set of training samples. The trained machine learning model 400 can be used for making inferences or another suitable task for which the model is trained.

In some embodiments, one or more AI-accelerating processors 100 are used to accelerate any of the computations involved in training the machine learning model 400 and making inferences by the machine learning model 400. Data and functions (e.g., input data, kernels, functions, layers outputs, gradient data) in machine learning may be saved and represented by one or more matrices. Common operations related to training and inference of a machine learning model 400 may include matrix multiplication, matrix transpose, matrix elementwise operation, convolution, application of an activation function, determination of gradients, statistics, and aggregation of values in matrices (e.g., average, variance, standard deviation), matrix rank and size manipulation, etc. An AI-accelerating processor 100 may be designed to accelerate one or more types of computations that are commonly encountered in training and/or inference of a machine learning model 400.

While the term matrix is commonly used in this disclosure, the datasets in a machine learning model 400 are not limited to a particular number of dimensions. Various techniques and architectures described in this disclosure may be applied to tensors that have different dimensions. The term matrices in this disclosure may include high dimensional tensors and are not limited to two dimensional tensors.

In some embodiments, an AI-accelerating processor 100 may provide different degrees of acceleration in the training of a machine learning model 400 and in accelerating the inference of the machine learning model 400. For example, in some machine learning models, such as a transformer-based LLM, training the model requires a higher level of precision than making inferences. In some embodiments, making inferences may be performed using low-precision computations once a machine-learning model is trained. As discussed in FIG. 2, the processing elements 212 of a systolic array 210 may be configured to perform low-precision arithmetic computations, such as computations that are limited to 8-bit precision or 4-bit precision. The AI-accelerating processor 100 in those configurations can drastically improve the computation speed and power consumption of a pre-trained LLM to make inferences. In some embodiments, an AI-accelerating processor 100 may also be used for training.

### Example Transformer Model Structure

FIG. 4B is a conceptual diagram of functional blocks of a transformer-based neural network model 420, in accordance with some embodiments. For simplicity, the transformer-based neural network model 420 is referred to as a transformer model 420. The transformer model 420 is an example of a machine learning model 400. An actual transformer model 420 may be a large language model that involves numerous nodes, such as a large number of decoders. The structure illustrated in FIG. 4B is part of a decoder for generating token attention. In a processing task that involves a transformer such as a language processing task, the input may take the form of a sequence of words (e.g., a prompt) that may be encoded to a sequence of input tokens. Each token represents a respective word in a latent space. Based on the input tokens, the transformer model 420 may repeatedly generate a sequence of output tokens in an autoregressive manner.

The transformer model 420 may include a positional encoder 421 that injects position information to the tokens. For example, the position information may be the order of words in a word string of a prompt in a language processing task, pixel and feature information in an image processing task, etc. The positional encoder 421 may use alternating sine function and cosine function to add position data to the tokens. The positional encoding data are added to the tokens to rotate the tokens at different degrees to signify positions.

In some embodiments, a transformer model 420 includes a set of N decoders, D1, D2, . . . , and DN. A decoder receives a set of input representations and generates a set of output representations. For example, the first decoder D1 generates a set of output representations. Each subsequent decoder may receive the set of output representations of a previous decoder and generate another set of output representations. For example, the second decoder D2 placed after the first decoder D1 may receive the set of output representations generated by the first decoder D1, and generate another set of output representations. This process is repeated until the set of output representations for the final decoder are generated.

The transformer model 420 may include an LM head block 470 that receives the set of output representations from the final decoder DN and generates an output token as the output for the current iteration.

As shown in FIG. 4B, a decoder in the transformer model 420 includes a first layer normalization block 422, a query-key-value (QKV) operation block 424, a split block 426, a self-attention block 428, a value weight block 430, a first add block 435, a second layer normalization block 440, a multi-layer perceptron (MLP) block 445, an MLP activation block 450, and a second add block 460. In some embodiments, the computations in one or more blocks in the decoder are accelerated by one or more AI-accelerating processors 100. While the operations in the first decoder D1 are described as an example, the remaining decoders in the set may include similar operations as the first decoder D1.

FIG. 4B illustrates a flow for attention mechanism of a transformer model 420. The transformer model 420 receives an input sequence of words. Each word may be converted into a token that takes the form of an embedding vector. The sequence of words may be represented as a matrix of embedding vectors with each embedding vector being arranged in a row of the matrix. The layer normalization block 422 receives an input dataset (e.g., the matrix of embedding vectors) and normalizes the data values to generate a normalized dataset (e.g., a normalized matrix).

In some embodiments, during training, the transformer model 420 may be trained in an autoregressive manner using masked label prediction. To simulate the prediction task, the transformer model 420 may apply masking to selected positions in the input sequence, wherein the masked tokens represent unknown values to be predicted in the sequence. The masking may be implemented within the decoder, such that each position in the sequence may attend only to previously seen or unmasked positions. The masked positions may be excluded from attention during self-attention computation and are predicted based on the contextual embeddings of unmasked tokens. The training objective may include minimizing the prediction error between the masked positions and their true labels.

The QKV operation block 424 receives the normalized input dataset and performs three separate projections to respectively generate a query matrix, a key matrix, and a value matrix. Specifically, the QKV operation may apply a QKV weight matrix, which is a trained set of parameters of the transformer model 420, to the normalized dataset. The trained set of parameters may be stored in memory of the AI-accelerating processor 100, such as in memory 120 and/or cached in matrix cache 215. The operation may include a matrix multiplication between a weight matrix and the normalized input dataset. The matrix multiplication can be accelerated using one or more AI-accelerating processors 100.

The split block 426 may split the output of the QKV operation block 424 into a query matrix, a key matrix, and a value matrix. The self-attention block 428 receives the query matrix, the key matrix, and the value matrix as the inputs and generates an attention matrix. The generation of an attention matrix includes multiplying the query matrix and a transposed version of the key matrix. Such matrix multiplication may be accelerated by one or more AI-accelerating processors 100. In generating attention scores, a softmax operation to each row of the attention matrix may be applied. For example, conceptually, the attention score may be represented by an equation attention=softmax (Q*K/Scale). One or more AI-accelerating processors 100 may be used to accelerate the computation of attention matrix and scores and the application of softmax functions.

The value weight block 430 receives data related to the attention score and generates an attention dataset. The output for each token is a weighted combination of value vectors with the weights given the attention scores determined in the self-attention block 428. The outputs of the value weight block 430 may be computed by a matrix multiplication between the value matrix and the attention matrix after softmax is applied. The matrix multiplication may likewise be accelerated by one or more AI-accelerating processors 100. The add block 435 concatenates results from various layers. The results of the attention sublayer, including results from the add block 435, may be further normalized using the second layer normalization block 440.

A decoder may include one or more multi-layer perceptron (MLP) blocks 445 that include additional neural network layers, which may take the form of feed-forward fully connected layers, such as in a structure similar to the one illustrated in FIG. 4A. One or more MLP blocks 445 may include an MLP activation block 450. In some embodiments, an MLP activation block 450, which typically includes a non-linear activation function, may be nestled between two linear MLP blocks 445. The MLP blocks 445 along with the MLP activation block 450 may be used to introduce non-linearity, perform feature extraction, reduce dimensionality and select tokens for next decoder. In some embodiments, the activation function used in the MLP activation block 450 may be any suitable activation function such as a sigmoid function, a hyperbolic tangent function (tanh), a rectified linear unit function (ReLU), or a Gaussian Error Linear Unit function (GeLU). Outputs of the MLP blocks may be further concatenated in the add block 460.

The output of a first decoder D1 is passed to a subsequent decoder. This process is repeated until the set of output data from the final decoder DN are generated. While each decoder may involve similar operations as the first decoder D1, the trained set of parameter values that are associated with the operations may be different from decoder to the decoder. The LM head block 470 receives output from the final decoder DN to determine an output token. Additional softmax operation may be performed at LM head block 470 to determine the final attention scores.

In this disclosure, various operations that are described in FIGS. 4A and 4B, such as matrix multiplications, vector dot products, softmax operations, and other linear or non-linear operations, may be referred to generally as machine learning operations or machine learning computations. The various operations that are described in FIG. 4B in association with the transformer model 420 may also be referred to as transformer operations or transformer computation. Those machine learning operations, including transformer operations, may be accelerated by one or more AI-accelerating processors 100 using the architecture and techniques described in this disclosure.

While in this disclosure the computations of AI-accelerating processors 100 are described as accelerating machine learning operations and transformer operations, in various embodiments an AI-accelerating processor 100 may also be used in accelerating other computations such as matrix multiplications that are not in a machine learning setting. Also, while the transformer model 420 is illustrated as a decoder only model, in various embodiments, a transformer model 420 in various embodiments may also take the form of an encoder-only model, an encoder-decoder model, etc. The encoder side's operation is similar to the decoder side except in some situations masking is not used in encoder.

### Example Software Compiling Process

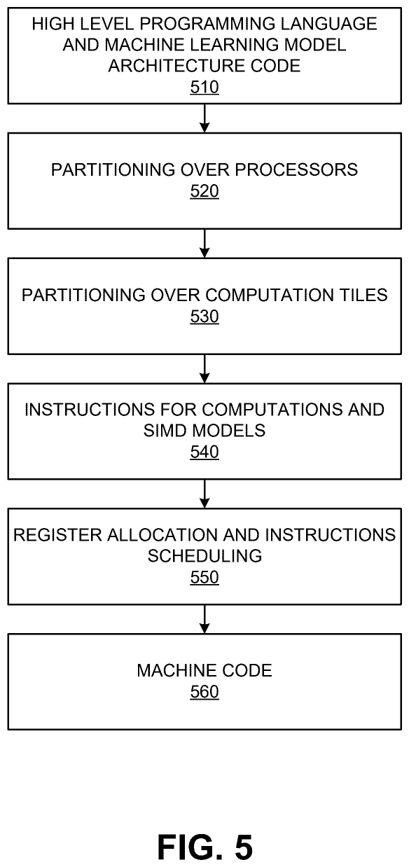

FIG. 5 is a flowchart illustrating an example process 500 to execute one or more AI-accelerating processors 100, in accordance with some embodiments. The process 500 illustrates how software code may be executed and compiled into machine code to be executed by one or more AI-accelerating processors 100. In various embodiments, the process 500 may include different, more, or fewer steps. The steps may also be performed in a different order from that illustrated in FIG. 5. In some embodiments, AI-accelerating processors 100 may be coupled with software that provides flexibility to a software engineer (e.g., a data scientist) to determine how data may be computed in parallel. The software related to AI-accelerating processors 100 may take the form of a library package that allows the software engineer to specify various parameters in controlling partitioning, scheduling, and load balancing of the AI-accelerating processors 100. This offers additional configuration flexibility that is not available in conventional processors and firmware designs.

At step 510, a machine learning model 400 may be coded in a high-level programming language that includes machine learning model architecture code. The high-level programming language may be PYTHON, C++, R, etc. and the machine learning model may be stored as an object that includes parameters specified by common machine learning libraries such as TENSORFLOW, PYTORCH, KERAS, etc. The software engineer may initially define the structures and hyperparameter ranges of the machine learning model. The final trained values of various weights may be determined through training of the machine learning model 400. In some embodiments, the machine learning model 400 may be pre-trained by a third party such as by an LLM provider or being resided in an open-sourced library. The machine learning model 400 may be incorporated in or in communication with an application 330 to make inferences, such as in generating text for the application 330. Whether the machine learning model 400 needs to be trained or is performing inference, one or more AI-accelerating processors 100 may be deployed to accelerate the computations in the machine learning model 400.

The programming language may incorporate a library that is related to the control of one or more AI-accelerating processors 100. At step 520, parameters in partitioning over AI-accelerating processors 100 may be specified. The partitioning over AI-accelerating processors 100 may be used in situations where multiple AI-accelerating processors 100 cooperatively perform computations, such as in a processor rack 350. Depending on the type of compiler used in AI-accelerating processors 100, those parameters in partitioning over AI-accelerating processors 100 may be specified in a high-level programming language or automatically by a compiler. In some embodiments, a large machine learning model 400, such as an LLM, is split and stored in a distributed fashion among multiple AI-accelerating processors 100. How the machine learning model 400 is split may be controlled by the software engineer using software instructions.

In some embodiments, at step 530, parameters in partitioning over computation tiles 112 may be specified. In some embodiments, in large matrix multiplication, a matrix is split into multiple subsets for computations. The computations of the subsets may occur in parallel among computation tiles 112 and/or in series over multiple computation cycles. These options may be specified in a high-level programming language manually or be specified automatically by a compiler. For example, a software engineer may use the imported library to control how a matrix should be split (e.g., in terms of dimensions and sizes) and stored in the computation tiles 112.

In some embodiments, at step 540, instructions for computations and SIMD models may be specified. An AI-accelerating processor 100 may use a series of collective operation instructions to perform a matrix multiplication using the grid of computation tiles 112, as discussed above in the description in association with FIG. 1B. Those collective operation instructions may be specified in a high-level programming language or automatically by a compiler. In some embodiments, a software engineer may use the imported library to control the computation steps and instructions of a matrix multiplication that is going to be performed in the grid of computation tiles 112. Other controls and parallelism instructions may also specified at the software level.

In some embodiments, the high-level software code is converted into intermediate-level code after step 540 and, at step 550, a compiler is used to generate register allocation and instructions scheduling. In some embodiments, the compiler is a low-level compiler that allows software to perform control of various things that are conventionally unavailable to a software engineer. For example, in some embodiments, unless not specified in software, the compiler does not perform determination related to memory allocation, data layout on the AI-accelerating processor 100, or parallelism instructions. Those instructions and parameters may be specified on the software level, thereby offering controls and flexibility to software engineers to determine how computations in a machine learning model 400 should be run in one or more AI-accelerating processors 100. A compiler may receive the parameters and instructions specified in step 510 through step 540 and convert higher-level code into machine code. In turn, the compiler may determine register allocations with the AI-accelerating processor 100 and determine the scheduling of instructions.

At step 560, machine code is generated and used to execute one or more AI-accelerating processors 100. The computations in a machine learning model 400 are thereby accelerated using the combination of specific hardware architecture and techniques described in this disclosure and parameters and instructions specified in the software.

### Example Collective Operations

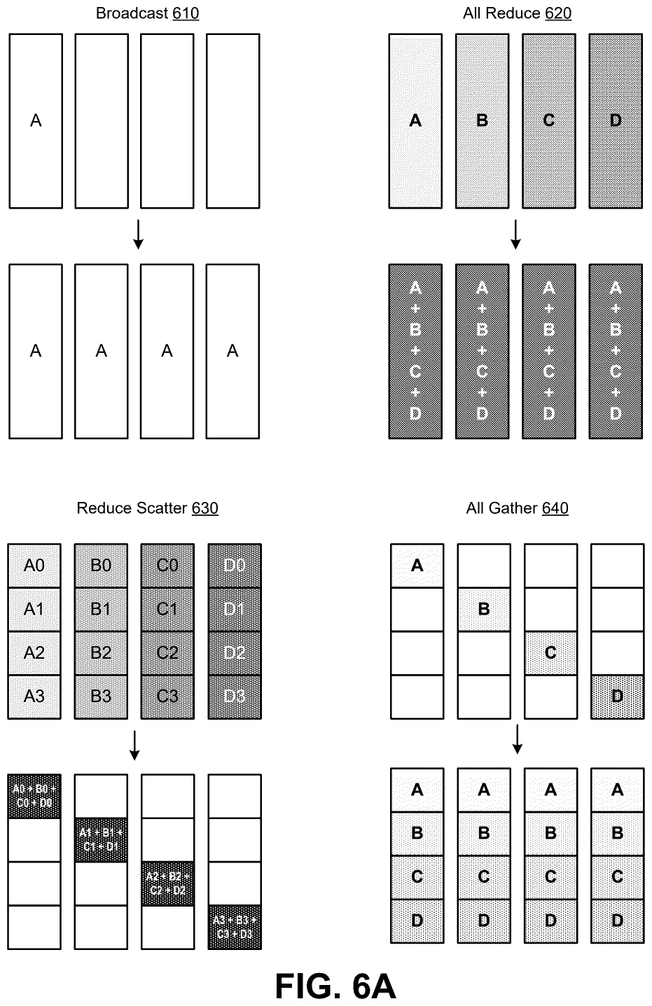

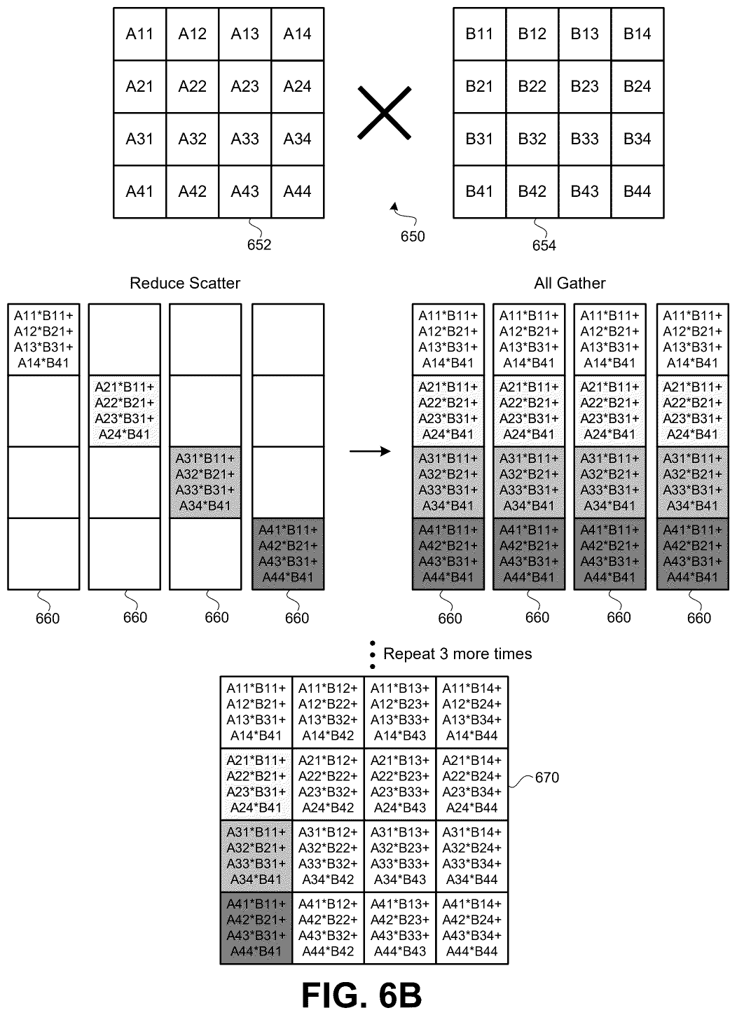

FIG. 6A is a conceptual diagram illustrating various examples of collective operations that may be performed by one or more AI-accelerating processors 100, in accordance with some embodiments. Collective operations specify how data are transmitted and computed in parallel programming. Examples of collective operations include broadcast, scatter, gather, reduce, all-reduce, reduce-scatter, all-gather, all-to-all, and other collective operations. The collective operations may be used as part of machine learning operations that are used by AI-accelerating processors 100 to accelerate the computation of machine learning models. For example, matrix multiplication can be carried out in AI-accelerating processors 100 using a series of collective operations.

The illustration 610 shows a broadcast pattern that distributes data from a source to a set of processing nodes. The same data is distributed to the set of processing nodes. The source can be any suitable source, such as another processing node, a memory address, etc. The broadcast operation may be completed in a single time step or a series of time steps. For example, in one case, each processing node in the destination set may fetch the data from the same memory address so that all of the processing nodes in the set receive the same data at the same time step. In another case, at one time step, the data may be transmitted from a first processing node to a second processing node. At the next time step, the second processing node may continue to pass the data to a third processing node until all processing nodes in the set sequentially receive the data.

The illustration 620 shows an all-reduce pattern that causes all processing nodes to perform reduction operations. Reduction may be used to collect data from different processing nodes and combine the data. Reduction may be any type of associative data aggregation, such as accumulation (summing the data), maximum, minimum, certain statistical reduction, or another suitable associative operation. In an all-reduce operation, each of the processing nodes is performing the same reduction operation to achieve the same result. All-reduce operations are common in machine learning operations. For example, in some cases in training of a machine learning model, gradient data are all-reduced to determine an overall gradient. A value of the resultant matrix in matrix multiplication may also be generated by all-reduce. Typical reduction may include accumulating computation data from various processing nodes. In some embodiments, to improve the efficiency of performing all-reduce, the all-reduce process may be divided into a reduce-scatter operation and an all-gather operation.

The illustration 630 shows a reduce-scatter pattern that causes individual processing nodes to perform their respective reduction operation and store a portion of the computation results. As such, the overall computation result is scattered among the processing nodes. Each processing node contributes to a portion of the overall result. The overall reduction operation is distributed among the processing nodes in a balanced manner. Typically, each processing node at the end receives a result that is a component of the overall result and the component result of each processing node is contributed by all of the processing nodes in the set.

The illustration 640 shows an all-gather pattern that causes processing nodes in a set to gather data that are distributed among other processing nodes. The end result is that all of the processing nodes receive the same data that are gathered from the processing nodes in the set. The data gathering process may be performed in an asynchronized manner (e.g., not every processing node receives the same data at the same time step) until every processing node receives all of the data gathered. The reduce-scatter operation shown in illustration 630 can be combined with the all-gather operation shown in illustration 620 to generate the result of an all-reduce operation shown in illustration 620.

FIG. 6B is a conceptual diagram illustrating how a matrix multiplication may be performed using a series of alternating reduce-scatter and all-gather operations in one or more AI-accelerating processors 100, in accordance with some embodiments. A matrix multiplication may be part of a machine learning operation that is accelerated by one or more AI-accelerating processors 100. For example, matrix multiplications are common in both training and inference in a transformer model 420, as discussed in FIG. 4B.

The matrix multiplication process 650 may be performed between a left matrix A 652 and a right matrix B 654. While both matrices are illustrated as having the size of 4×4 elements, the matrices can be of different sizes and do not need to be square. The process 650 may be performed by a set of processing nodes 660, such as four processing nodes.

In some embodiments, the matrix multiplication may be performed as a series of reduce-scatter 662 and all-gather 664 operations. In a reduce-scatter operation 662, a column (or a row, depending on how data are arranged) of the right matrix B 654 may be treated as a column vector, and the values in the column may be scattered to the four processing nodes 660 in the set. For example, each processing node 660 may respectively receive one of the values in the first column B11, B21, B31, and B41. The processing nodes 660 may fetch the rows in the left matrix A 652 and perform multiplications between an individual element of left matrix A 652 and an individual element of right matrix B 654. The multiplication results of the individual elements are accumulated (reduced) at each processing node 660. Since each processing node 660 handles the multiplication and accumulation of different individual elements, the partial results of the overall matrix multiplication 650 are scattered among the processing nodes 660, as illustrated in FIG. 6B.

The scattered results are followed by an all-gather operation 664 so that the individual processing node 660 gathers the multiplication results of one of the column vectors of the right matrix B 654. In some embodiments, a scattered result stored in a processing node 660 is transmitted to all other processing nodes 660 in the set. The end result of the all-gather operation 664 is that each processing node includes a column vector of the final matrix C 670. For example, FIG. 6B illustrates that the combination of reduce-scatter 662 and all-gather 664 operation generates the leftmost column vector of the final matrix C 670. Additional column vectors of the final matrix C 670 may be generated by repeating the reduce-scatter and all-gather operations for other column vectors of the right matrix B 654.

The processing of different column vectors of the right matrix B 654 may be performed by repeating the reduce-scatter 662 and all-gather 664 operations multiple times using the same set of processing nodes 660. For example, in the next set of operations, a second column vector of the right matrix B 654 that includes the values B12, B22, B32, and B42 may be scattered to the processing nodes 660. The same type of reduce-scatter followed by an all-gather operation is repeated to generate the second column vector of the final matrix C 670. The operations may be repeated for the third column vector of the right matrix B 654 which includes the values B13, B23, B33, and B43, and also for the fourth column vector which includes the values B14, B24, B34, and B44.

The precise operation of matrix multiplication carried out by one or more AI-accelerating processors 100 may depend on implementations and the sizes of the two matrices. For example, in some embodiments, instead of using the same set of processing nodes 660 to generate column vectors of the final matrix C 670 by repeating operations, additional sets of processing nodes 660 may also be used to handle different column vectors of the right matrix B 654 in parallel with other sets of nodes and the resultant column vectors of the final matrix C 670 are combined to form the final matrix C 670. In some embodiments, instead of breaking up the right matrix B 654 into column vectors, an AI-accelerating processor 100 may also break up the left matrix A 652 into row vectors and perform a series of reduce-scatter and all-gather to obtain the same final matrix C 670. In some embodiments, both the left matrix A 652 and the right matrix B 654 may have one or more dimensions that are larger than the size of the set of processing nodes 660. One or both matrices may be broken down into sub-matrices and the reduce-scatter-all-gather operations may be repeated until all of the required computations are performed to generate the final matrix C 670.

### Introduction to Load Balancing

Some machine learning models involve dynamically routing and activations to different parts of the neural network. For example, mixture of expert (MoE) neural networks, other transformer-based neural network, large language models (LLM), multi-modal models, sparsely activated neural networks, conditional computation architectures, dynamically configurable neural network topologies, and other models employing selective activation of computational pathways may conduct different degree of routing and activation of sub-networks. The term MoE model may be used as a generalized term to cover various architectures of models that use dynamic routing and activation. An example of an input data sequence (such as in the case of a token or a series of tokens in a sequence model) is dynamically selected to be run in one or more sub-networks. The input data instance runs on the selected one or more sub-networks and not the others. Other forms of dynamic routing include scenarios where an example dynamically selects some subset of values to load from memory, perhaps as in a sparsely accessed “context” for “long context” language models (note that load balancing, as described herein, may be performed for these other forms of dynamic routing). The sub-networks of a neural network may be referred to as experts, which may take the form of any portion of a neural network to which data can be dynamically routed. In this disclosure tokens may be used interchangeably with data sequence and may be used as the primary example of units that are dynamically routed.

Since the experts are independent, they can be processed in parallel on different cores. A core may take the form of any unit of a computing element. Example cores include computing devices, chips, processing units within chips, processors (e.g., 100), processing elements, tiles (e.g., 112), compute nodes, or any combination thereof. The size of a core and division of cores may vary depending on hardware implemented and connections. Using cores to implement experts in parallel can speed up a computation by using the memory bandwidth and processing power of multiple cores in parallel. Additionally, using cores may reduce memory footprint on each core, because each core may store one or more experts rather than all experts of a machine learning model (e.g., an MoE model). This may be referred to as “expert parallelism.” Note that expert parallelism is independent of, and can be combined with, other forms of parallelism for neural networks, such as tensor parallelism, sequence parallelism, pipeline parallelism, and data parallelism.

However, the performance advantages of expert parallelism are reduced in the presence of load imbalance between experts. If one expert receives more tokens than other experts, the processing time of that expert's core is increased, and the other cores will have to wait for the most-loaded core to complete. This effect is known as load imbalance. The bigger the load imbalance, the less the speedups from expert parallelism are. For example, load imbalances are frequently larger than a 2x difference between the most loaded expert and the average loaded expert.

This disclosure describes embodiments which can achieve the advantages of expert parallelism (e.g., reduced memory footprint and improved processing time) while also reducing or avoiding inefficiencies due to load imbalance. These embodiments may be referred to as load balancing, which may take the form of probability distribution-based load balancing.

In some embodiments, the load balancing operations among a plurality of cores may be controlled through instructions executed at one or more control units of a control unit system. A control unit system may take the form of one or more control units. A control unit may take the form a processor or portion of a processor that can perform load balancing operations. A control unit (or part of a control unit) may reside on or be part of a core. Thus, for example, a control unit system may be distributed among multiple (e.g., all) cores. A control unit may be part of an AI-accelerating processor or a separate component. Example control units include (e.g., host) CPUs (e.g., 302) and controlling circuits (e.g., 130). Although a single control unit may be referred to in a given description herein, this is for simplicity and multiple control units of a control unit system may be used to perform one or more load balancing operations. Furthermore, if a control unit system includes multiple control units, the multiple control units may operate individually or collectively to perform a set of one or more load balancing operations. For example, a control unit system performs a set of load balancing operations, and this example control unit system includes a control unit on a core and a (e.g., host) CPU control unit, where the control unit on the core performs a subset of the load balancing operations and the CPU control unit performs another subset of the load balancing operations. For example, the CPU performs expert-to-core assignments and token routing is performed by the control unit on the core.

Load balancing steps may be performed by a control unit system in a variety of different systems. For example, a system (e.g., including one or more computing devices 300 and/or processor racks 350) includes a plurality of computing elements, where each computing element is implemented as an integrated circuit for accelerating artificial intelligence (AI) computations. The system also includes a one or more control units of a control unit system for load-balancing the plurality of computing elements, where the one or more control units of the control unit system are configured to perform one or more load balancing steps as described herein. In another example, a data-center system (e.g., including one or more computing devices 300 and/or processor racks 350) includes a plurality of interconnected AI-accelerating cores arranged in one or more server racks and one or more control units (e.g., CPUs) of a control unit system for load-balancing the plurality of AI-accelerating cores. The one or more control units, when executing a set of load-balancing instructions, are caused to perform one or more load balancing steps as described herein.

Instructions for load balancing may be provided by software. Load balancing software may provide flexibility to a software engineer (e.g., a data scientist) to determine how and when load balancing should be performed. Load balancing software may take the form of a library package that allows a software engineer to specify various parameters in controlling the load balancing e.g., of AI-accelerating processors 100. In some embodiments, load balancing software is preinstalled e.g., in storage unit 330 of a computing device 300 or a processor rack 350. For example, the instructions for load balancing may be provided as part of the instructions used in FIG. 5, such as in instructions for computations and SIMD models 540, or in another suitable software instruction set.

In some embodiments, the load balancing may include two types of load balancing operations (however load balancing does not require both types to be performed). The first type includes a control unit approximating the expected distribution of tokens among experts and allocating the experts to cores to reflect this expected distribution. The second type includes distributing tokens destined for specific experts among cores that the experts reside on according to the fraction of each core that each expert occupies. Both types are further described below. The first type of load balancing operations may be performed between processing of larger batches of tokens (e.g., ˜16k tokens) and the second type of load balancing operations may be performed between processing of smaller batches of tokens (e.g., ˜1k tokens), however this is not required. Thus, the first type may be referred to as coarse-granularity load balancing operations and the second type may be referred to as fine-granularity load balancing operations.

To give a brief example, a machine learning model (e.g., an MoE model) includes four experts (E1, E2, E3, and E4), that are executed across two cores (Core A and Core B). In an example situation, the incoming tokens are expected to be heavily imbalanced among the experts: approximately 60% of tokens are expected to be processed by E1, 20% by E2, and 10% each by E3 and E4 (this example assumes the workload for each expert to process a single token is equal and assumes each core has equal capabilities). For simplicity, fetching or pre-loading of weights and parameters corresponding to a sub-network at a core may be referred to as the core storing an expert. In a naïve expert-to-core mapping, Core A stores E1 and E2 while Core B stores E3 and E4. Under this arrangement, Core A processes 80% of all tokens while Core B processes only 20%, resulting in significant load imbalance e.g., increased latency and under-utilization of Core B.

To address this imbalance, first type load balancing operations may be performed to store experts differently on the cores. For example, E1 is stored on both Core A and Core B, E2 is stored on Core A, and E3 and E4 are stored on Core B. Assuming, each core receives half of E1's predicted workload, this new mapping results in each core receiving 50% of the tokens. In other words, half of the tokens for E1 (30% of the total tokens) and all tokens for E2 (20% of the total tokens) are routed to Core A, resulting in Core A receiving 50% of the total tokens. Similarly, half of the tokens for E1 (30% of the total tokens) and all tokens for E3 and E4 (10% each of the total tokens) are routed to Core B, resulting in Core B receiving 50% of the total tokens.

However, even though E1 is stored on both cores, this does not guarantee each core will receive half of the tokens for processing E1 at runtime. For example, one of the cores may receive significantly more of the tokens for E1 than the other, which would result in a load imbalance. Thus, second type load balancing operations may include (a) determining a routing plan for tokens that describes how tokens for experts are routed among the cores and (b) implementing the routing plan at runtime. In this example, the routing plan specifies that 50% of the tokens for E1 should be routed to Core A and the other 50% should be routed to Core B. The routing plan also specifies that all tokens for E2 should be routed to Core A and all tokens for E3 and E4 should be routed to Core B. Thus, by implementing the routing plan, the cores are load balanced.

In some embodiments, load balancing may be performed using expert distributions, expert assignments, and/or token routing plans. An expert distribution may take the form of a distribution that indicates how a set of incoming tokens are expected to be distributed to experts of a corresponding machine learning model (e.g., an MoE model). Said differently, an expert distribution indicates the expected portion of tokens to be processed by the experts (e.g., the likelihoods of tokens being processed by individual experts). An expert distribution may be determined based on the distribution of tokens in a previously processed set of tokens (using the assumption that the incoming tokens have a similar distribution as the previous set). Expert distribution trees are examples of expert distributions. Expert distribution trees are further described below. In some embodiments, expert distributions are known or previously determined. In these embodiments, load balancing operations may or may not include determining an expert distribution.

An expert assignment may take the form of a load distribution, which is a distribution that indicates how the cores are expected to be utilized in the computations of the tokens. For example, an expert assignment indicates the expected portion of tokens routed to each of the cores (e.g., the likelihoods of tokens being routed to individual cores). An expert assignment may be determined by measuring the hardware occupancy of the experts in each of the cores for computation of a set of tokens and assuming an incoming second set of tokens will result in similar hardware occupancy. Measuring the hardware occupancy may include a control unit measuring the number of operations of each core during computation of a first set of tokens e.g., integer operations, binary operations, or FLOPs (floating point operations).

In various embodiments, the occupancy of cores may be determined in one or more suitable ways. In some embodiments, occupancy of cores assigned to experts of an MoE model may be determined based on routing metadata generated during execution of the model. For example, an MoE model may include a routing sub-network that may be referred to as a gating network or a routing network. The routing sub-network may assign, for each token or input data element of a batch, one or more expert identifiers. A mapping between expert identifiers and cores may be established, such that the number of tokens assigned to each expert can be determined from the routing metadata. Because each expert identifier is associated with a particular core, a system of multiple cores may determine a load value or utilization estimate for each core by counting the tokens assigned thereto during one or more inference or training passes.

In some embodiments, hardware occupancy of cores may be measured by instrumenting execution of expert sub-networks with performance monitoring hooks. Such hooks may record metrics corresponding to operation invocations, kernel execution durations, or other processing cycles attributable to execution of expert computations. The recorded metrics may be generated, for instance, by profiling interfaces provided by the underlying hardware platform or execution framework, such as those that measure elapsed execution time, number of dispatched compute operations, or percentage of active execution units. The measured values may then be associated with the core and expert that produced them, providing a direct indication of computational occupancy.

In some embodiments, the occupancy of cores may be determined by querying one or more performance counters or telemetry interfaces exposed by the cores themselves. Such counters may indicate, for example, streaming multiprocessor occupancy, memory bandwidth utilization, instruction throughput, or other operational statistics. The system may obtain values from such counters during or after execution of expert computations, and may correlate the values with routing metadata to attribute usage to particular experts and their associated cores. This allows direct measurement of hardware-level utilization without relying solely on logical token routing counts. In some implementations, the counters may also report a quantity of operations performed, such as a number of binary operations, floating point operations (FLOPs), or other arithmetic or logical operations.

In some embodiments, data indicating which cores execute which expert computations for specific tokens may be obtained from logs generated by a distributed execution runtime. The runtime may perform, for example, one or more collective communication operations to exchange token representations between cores based on routing metadata. During such operations, the runtime may output structured log entries indicating, for each core, the expert identifier(s) executed thereon, the corresponding token identifiers, and execution timing information. These log entries may be aggregated locally or centrally to determine occupancy statistics, identify load imbalances, or perform dynamic reallocation of experts among cores.

An expert assignment may also indicate how experts are assigned to cores. Said differently, an expert assignment indicates which experts are stored (or are expected to be stored) on cores to implement a machine learning model (e.g., an MoE model). Expert assignment trees are examples of expert assignments. Expert assignment trees are further described below.

A token routing plan may take the form of a plan that describes how tokens selected to be processed by experts are routed among cores that store those experts. Token routing trees are example token routing plans. Token routing trees are further described below.

For ease of description, the following descriptions describe load balancing using expert distribution trees, expert assignment trees, and token routing trees. A tree is a hierarchical structure that includes nodes connected by edges, with one designated root node and zero or more child nodes, where each child has exactly one parent. Trees can be implemented in various ways, such as tables (e.g., alias tables), linked nodes with pointers or references, arrays, adjacency lists, and parent arrays. However, the use of trees for load balancing is not required. As previously stated, expert distribution trees are examples of expert distributions, expert assignment trees are examples of expert assignments, and token routing trees are examples of token routing plans. Thus, descriptions of expert distribution trees in the following descriptions are more generally applicable to expert distributions, descriptions of expert assignment trees in the following descriptions are more generally applicable to expert assignments, and descriptions of token routing trees in the following descriptions are more generally applicable to token routing plans.

### I. Expert Distribution Trees

The distribution of expert choices in a set of tokens can be represented by a probability tree. A probability tree is a type of decision tree where leaves represent possible events in some (e.g., discrete) probability distribution. For a distribution of experts, the events (leaf nodes) identify the experts. This disclosure refers to such trees as “expert distribution trees.”

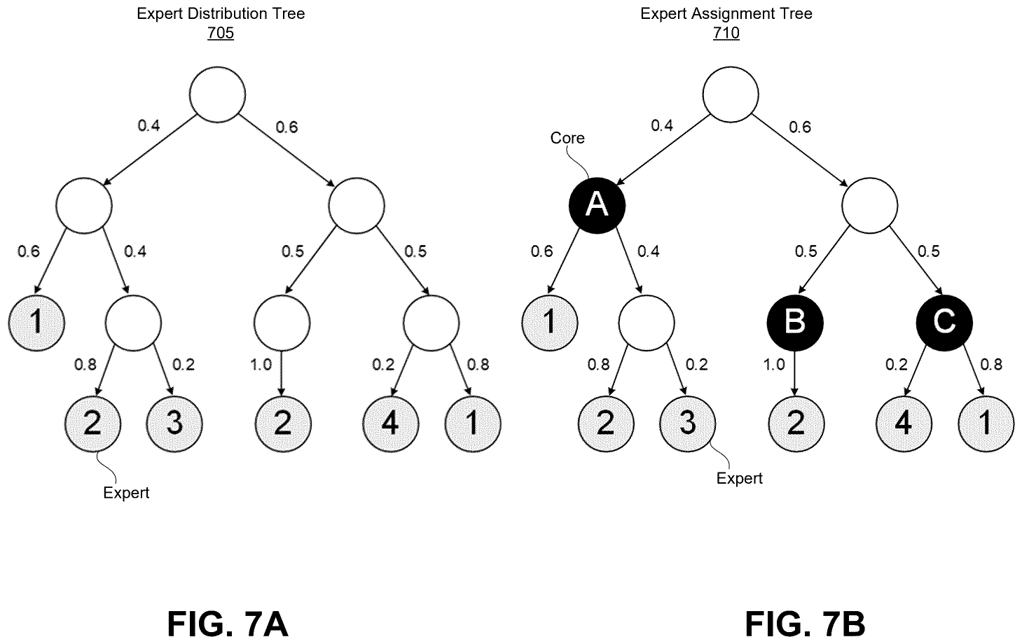

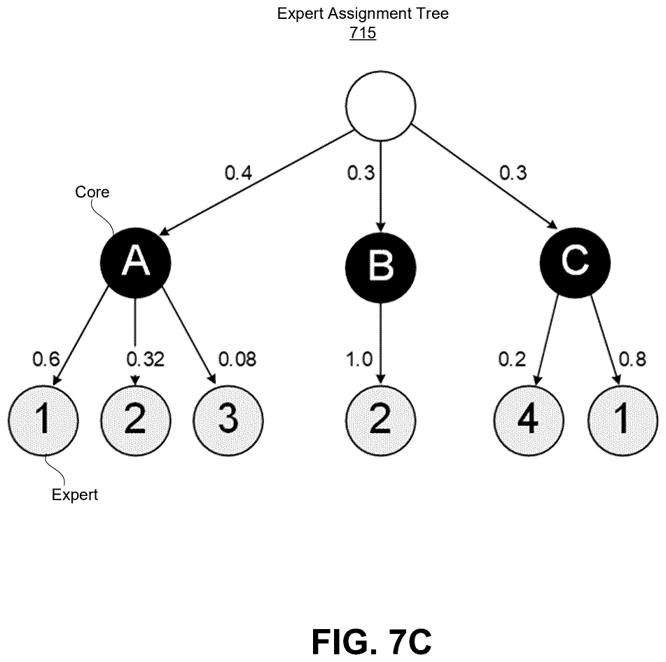

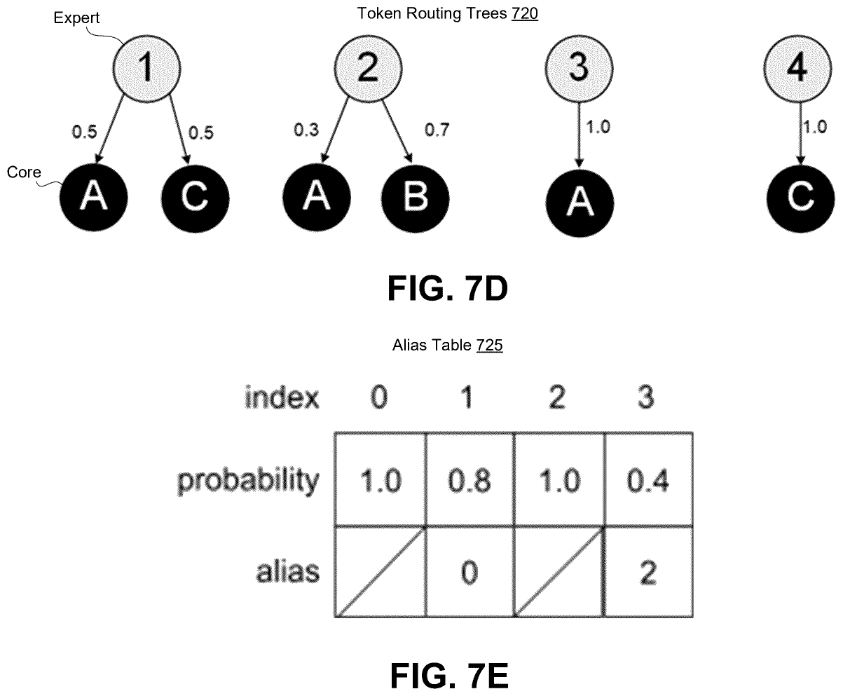

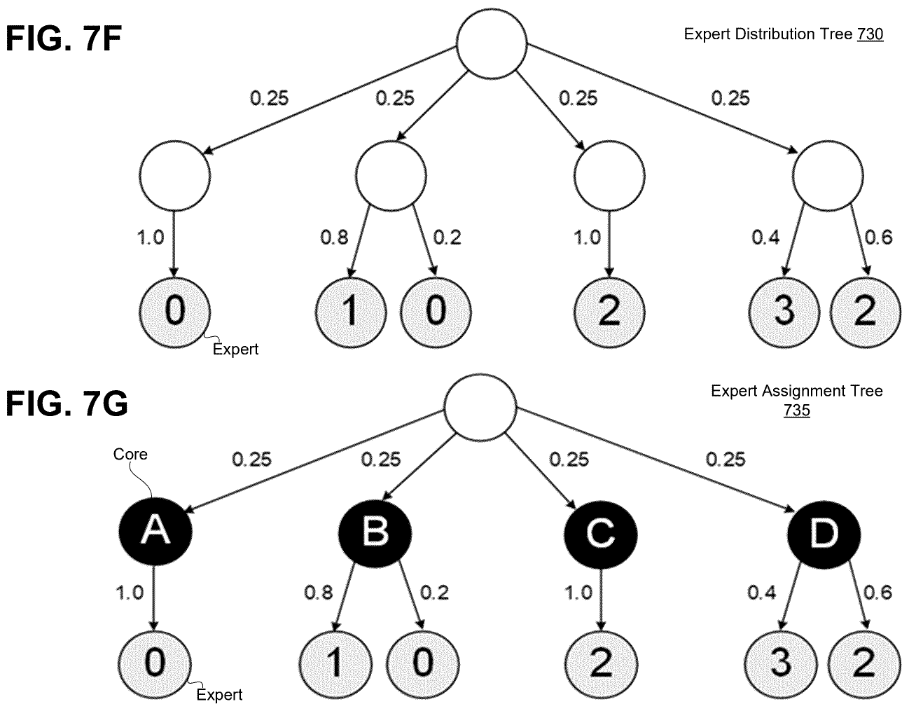

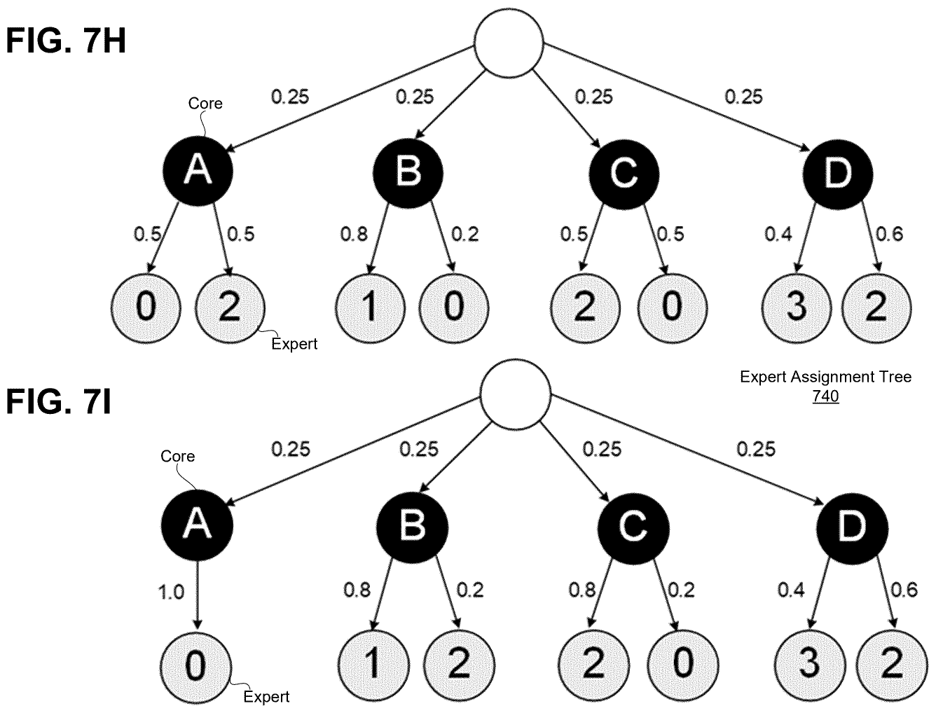

FIG. 7A illustrates an example of an expert distribution tree 705. In this example, there are four possible experts (labeled 1 through 4), and the edge weights are normalized (i.e., are probabilities). The probability of a random token in the set being routed to a specific expert can be determined by following the path from the root node to the leaf node for that expert and multiplying the probabilities. For example, a token will be processed by expert 3 with probability 0.4×0.4×0.2=0.032. If there are multiple leaf nodes for one expert, the probabilities add: for example, a token will be processed by expert 1 with probability 0.4×0.6+0.6×0.5×0.8=0.48. Additionally, multiple leaf nodes corresponding to the same expert may be merged (e.g., resulting in a directed acyclic graph or dag). The distinct paths of the tree 705 that lead to the same expert are then summed over to obtain the probability for that expert.

There are many equivalent expert probability trees for the same distribution, for example, obtainable by removing or introducing intermediate nodes or by coalescing or splitting leaf nodes corresponding to the same expert. To sample from a tree, one starts at the root node and draws a random number to determine which of its children to follow, weighted according to the labels on the node's outbound edges. This process is repeated at each non-leaf node until a leaf node is reached. At that point, expert corresponding to the leaf node is returned.

### II. Expert Assignment Trees

A probability tree that represents an expert distribution (e.g., 705) can be augmented to incorporate the allocation of experts to cores by anointing some intermediate nodes to represent cores, and the subtrees below them to represent the expert distribution within each core. This disclosure refers to such trees as expert assignment trees (also referred to as load-distribution trees).

An example expert assignment tree 710 is illustrated in FIG. 7B. Expert assignment tree 710 is an augmentation of the expert distribution tree 705 to include cores in intermediate nodes. More specifically, A, B, and C represent cores, and leaf nodes 1, 2, 3, and 4 represent experts. In this example, core A is assigned 40% of the work, while cores B and C are assigned 30% of the work each (this could be, for example, because core A has 33% more compute resources than core B or core C). Core A can run experts 1, 2, and 3; core B can run expert 2; and core C can run experts 4 and 1.

A path leading from an intermediate node (representing a core) to a leaf node (representing an expert) may represent the fraction of that core's computing resources assigned to that expert. In the example of FIGS. 7B, 80% of core C's capabilities are assigned to expert 1 and the remaining 20% to expert 4. Example reasons for this include: because expert 1 receives 80% of the tokens routed to core C or because experts 1 and 4 each receive 50% of the tokens routed to core C but expert 1 takes four times the compute per token when run on core C.

As seen in these example figures, the trees elegantly account for not only different expert distributions but can also account for different computation capacity of cores and different computation requirements of experts.

An invariant for an expert assignment tree is that any path from the root node to a leaf goes through one core (intermediate) node. This allows the tree to represent a partition of the token to expert distribution among several cores. Indeed, any other description of such a partition is equivalent to a tree representation as in the example of FIG. 7C. Note that core (nodes) can be arranged into groups by adding additional levels of intermediate nodes.

As with the expert distribution trees, there are many equivalent trees that describe the same assignment in a given expert assignment tree. For example, the expert assignment tree 710 in FIG. 7B represents the same assignment as the expert assignment tree 715 in FIG. 7C.

If the distribution of experts in a set of tokens matches the probability distribution described by this tree (and any compute capability differences among cores are correctly reflected), load balancing may be improved or achieved.

### III. Representing Token-To-Core Distributions

As previously stated, expert assignment trees (which are augmented expert distribution trees) indicate which experts are stored in each core, and the portion of the tokens each expert is expected to receive. However, it may not be clear from an expert assignment tree how a given token (which was selected to be processed by a specific expert) should be routed among the cores (since an expert assignment tree describes the distribution of tokens among all of the experts). Thus, separate trees can be constructed for each expert where the leaves represent cores (and each root node represents an expert). These trees are referred to as token routing trees (e.g., see the token routing trees 720 in FIG. 7D).

Thus, using token routing trees, all tokens routed to each expert can be divided by a control unit among the relevant cores to balance the workloads assigned to each core (e.g., accounting for different core compute capabilities). In the example of FIG. 7D, for expert 3, all tokens are routed to core A. Similarly, for expert 4, all tokes are routed to core C. Tokens to be processed by expert 1 are routed (e.g., distributed) to cores A and C with half of the tokens going to each. Finally, tokens selected to be processed by expert 2 are routed to cores A and B such that core A receives approximately 30% of them and core B receives the other 70%.

Note that there are many possible trees for each token-to-core distribution. For example, intermediate nodes can be added or removed like in the trees previously described (e.g., leaf nodes can be coalesced).

IV. Estimating Expert Distributions

A control unit can determine the distribution of tokens to experts using any distribution estimation technique. The control unit may then construct an expert distribution tree based on the determined distribution. For example, tokens arriving over some period of time are binned by the experts selected to process the tokens and each bin is counted. Each expert is assigned to a node which is a direct descendant of the root node. The edge connecting two nodes is labeled with the count of tokens seen for that expert. The counts may or may not be normalized in some way (e.g., to represent proper probabilities). As previously described, a tree may be constructed using an alias table, where the first “level” of this table (the level with a probability entry) corresponds to an intermediate node and either the index in the table or the second level (which redirects to another index) corresponds to a leaf node. As previously stated, each alias table may directly correspond to a probability tree with the root's direct children being intermediate nodes that correspond to the table indices, and their children being leaf nodes that correspond to the choices in each table entry. That being said, a tree may be constructed in other ways e.g., provided the invariant that there is only one core node on any path from the root to a leaf.

Many variants for determining this distribution are possible. For example, a sampled subset of tokens are counted (according to the selected experts), instead of all tokens. In this example, the measured counts may be weighted so that more recent arrivals have higher weight. The counts may or may not be normalized e.g., to represent probabilities.

If different experts do different amounts of work per token, the control unit can adjust the weights of an expert distribution to account for this. For example, the work to evaluate a token assigned to a “heavier” expert corresponds to that of more than one token assigned to a “lighter” expert (in this context, the heavier expert performs more work per token than the lighter expert). The specific weight adjustment may depend on how much slower the heavier expert is relative to the lighter expert e.g., on a per token basis.

For example, in an example scenario the actual distribution of two experts requested by a set of tokens is uniform [0.5, 0.5]. In other words, each expert will receive the same number of tokens. However, suppose expert 0 takes three times as long as expert 1 to process a token. To reflect this, the control unit may adjust the expert probabilities by multiplying them by these runtime factors (3× or 1×) and normalizing: [0.5×3/(3+1), 0.5×1/(3+1)]=[0.75, 0.25]. A balanced expert assignment tree built based on this adjusted distribution will thus assign proportionally more cores to expert 0, reflecting a balanced load in terms of the amount of computation to process the tokens.

As previously discussed, equivalent trees can be arrived at by adding intermediate nodes, splitting leaf nodes, etc.

### V. Constructing Expert Assignment Trees

There are many ways for a control unit to construct expert distribution trees, and therefore many ways to construct expert assignment trees. One example is the use of alias tables.

In some embodiments, an alias table may take the form of a representation of a discrete probability distribution that is equivalent to a specific kind of probability tree. Each table entry contains a cumulative probability consumed by the entry's own index (that is, the probability that this index is returned when sampling), and an alias index that is returned otherwise. For example, the probability distribution over four events (or experts): [0.3, 0.2, 0.4, 0.1] (where the leftmost index is 0 and the rightmost index is 3) can be represented by the alias table 725 in FIG. 7E. The table can be represented more compactly as “[(1.0, nil), (0.8, 0), (1.0, nil), (0.4, 2)],”where each (probability, alias) pair corresponds to a table entry.

To sample from this table, a random index i is drawn uniformly at random (u.a.r.) from [0, 1, 2, 3], and the cell corresponding to index i is accessed. Another random number r is drawn u.a.r. from [0,1), and compared to the probability p in that cell. If r<p, the cell's index is returned as the sampled event (expert). Otherwise, the alias is returned as the sampled event. In this example, the aliases for indices 0 and 2 don't matter because their probabilities are 1.0 and the aliases will never be selected; these aliases are therefore shown as crossed out.

For example, suppose i is randomly drawn from [0, 1, 2, 3]. If i=0; then the sampling algorithm always returns 0. If i=1, then we also draw r u.a.r. from [0,1). If r<0.8, then the algorithm returns 1; otherwise it returns 0. Since no other entries have 0 as an alias, it can be verified that 0 is returned with probability 0.25+(1−0.8)×0.25=0.3, as desired.

Note that each alias table directly corresponds to a probability tree with the root's direct children being intermediate nodes that correspond to the table indices, and their children being leaf nodes that correspond to the choices in each table entry. For example, the alias table 725 corresponds to the expert distribution tree 730 in FIG. 7F.

Conversely, an alias table representation can be extended to contain multiple aliases by observing that an alias table is an adjacency list that represents the probability tree, where each alias contains the cumulative probability consumed thus far (including by the entry's original index) and the alias index itself. With multiple aliases, the probability stored with each alias is the cumulative probability of all the previous choices being selected; the sampling procedure then compares the random number r to each successive cumulative probability to select the return value.

### A. Constructing Alias Tables

Alias tables may be constructed through any suitable way. By way of example, the element probabilities are split in the desired discrete distribution into two sets: lows with probability <1/N, and highs with probability ≥1/N. A low element can be fully represented in just one table entry (because its probability p<1/N). For each of these, assign it to a new table entry. Set the table entry probability to reflect the low element's probability and set the alias of that entry to an element chosen from the highs (it will be more than enough because all highs have probability p≥1/N). Then, update the probability of the chosen high element to reflect the portion “consumed” by the table entry just created (which may move the element into the low set), and recurse. There may be left some elements with probabilities exactly 1/N. In the Vose algorithm those are assigned to their own table entries without any aliases, like in the example alias table 725. Note that the last two loops of the Vose algorithm are linear time because the loop counters decrease monotonically to 0. In the first loop the sum decreases by at least one in every step, so eventually one of them will be zero, so that is also linear time.

### VI. Constructing Expert Assignment Trees from Alias Tables

A control unit may construct a load-balanced expert assignment tree (e.g., 710) from an estimated expert distribution (e.g., 705) by first constructing an alias table (which represents an expert distribution tree) and then revising the alias to become an expert assignment tree. For example, recall that the following alias table [(1.0, nil), (0.8, 0), (1.0, nil), (0.4, 2)] corresponds to the expert distribution tree 730 of FIG. 7F. To revise the alias table to become an expert assignment tree, a control unit may assign each intermediate node to a single core, as illustrated in the example expert assignment tree 735 of FIG. 7G. This is similar (e.g., equivalent) to assigning a core to each index in the corresponding alias table. If different experts use (e.g., require) different amounts of work per token, the control unit may construct an expert assignment tree after adjusting the expert distribution tree to account for these differences, as previously described.

### VII. Increasing the Number of Experts Assigned Per Core

In the example above (with respect to FIG. 7G), some cores are assigned to two experts and other cores are assigned to one expert (e.g., core A only stores expert 0 but core B stores expert 1 and expert 0). This may be acceptable if the actual expert distribution matches the estimated expert distribution (e.g., within a deviation threshold). However, if the actual distribution has noise (or drift), e.g., above the deviation threshold, the single-expert cores will be less resilient to noise (or drift).

To lower the potential effect of noise (or drift), a control unit may split each leaf node (representing experts) with only one assigned expert in two and exchange an expert with an expert from another split leaf. In this context, ‘splitting’ a leaf node refers to adding a new leaf to an intermediate node that previously had only a single leaf node (so that the original leaf node and the new leaf node share the same intermediate node). Practically, splitting a leaf node refers to a control unit storing a second expert on a core which previously stored only a single expert (or is expected to store only a single expert).

FIG. 7H illustrates an example splitting technique applied to the expert assignment tree of FIG. 7G. More specifically, leaf nodes under cores A and C are split in two and exchanged so that cores A and C are each assigned 50% of expert 0 and 50% expert 2. Said differently, the probabilities are adjusted so that tokens to be processed by experts 0 and 2 are routed evenly (or substantially evenly) between cores A and C. Practically, in this example, the control unit (a) identifies core A only stores expert 0 and core C only stores expert 2 and (b) then stores a new copy of expert 2 on core A and a new copy of expert 0 on core C. Alternatively, if experts are not stored on cores yet, the control unit may identify the expected expert assignments and revise the assignments accordingly.

The previous example assumed an expert assignment tree included at least two single-expert cores. However, if an expert assignment tree has only one single-expert core, the control unit can split the leaf node of the single-expert core and exchange one of the leaf nodes with a leaf node from a core which already had two leaves (at least one of which is not the expert of the original single-expert core). However, this type of splitting does not require an expert assignment tree to include only one single-expert core. For example, FIG. 7I illustrates an expert assignment tree 740 similar to the expert assignment tree 735 with core C split using core B as the alternate. Practically, this may be performed by a control unit (a) identifying core C only stores expert 2 but core B stores experts 0 and 1 and (b) then storing experts 2 and 0 on core C and storing experts 1 and 2 on core B. Alternatively, if experts are not stored on cores yet, the control unit may identify the expected expert assignments and revise the assignments accordingly.

Splitting procedures can be repeated by a control unit to obtain an assignment of any number of experts per core (e.g., splitting is performed to achieve at least three experts per core). Note that splitting trades off per-core memory footprints for resilience to noise (or drift).

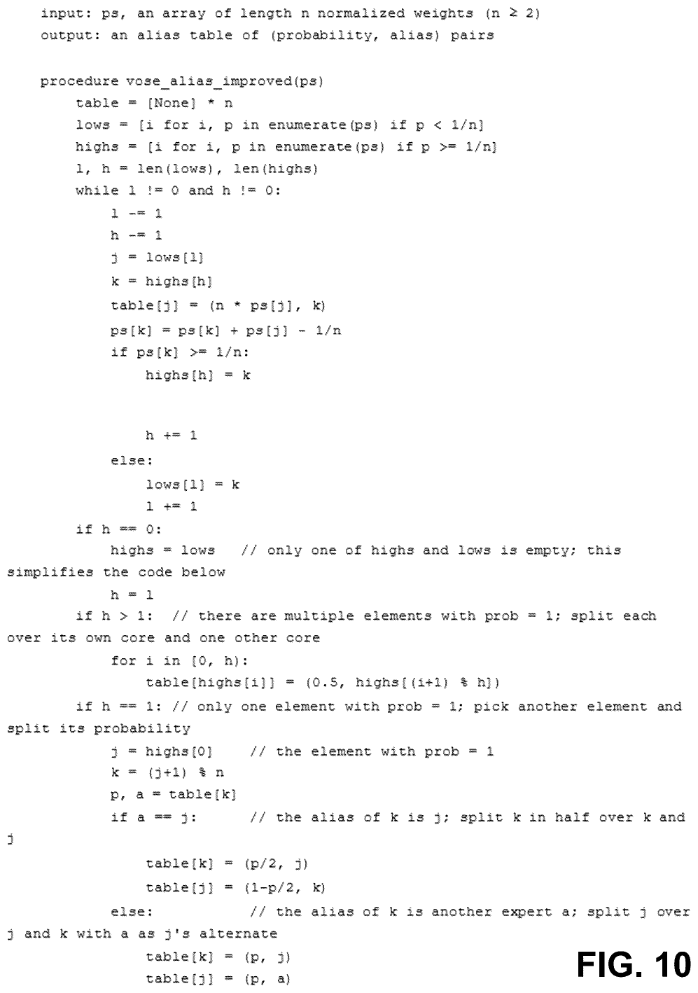

The pseudocode of FIG. 10 shows how to incorporate these splitting procedures to obtain two experts in every core. The procedure of FIG. 10 takes an array ps of length n containing normalized weights. A list table of length n is initialized with all entries set to None. Two lists are created: lows, containing the indices of elements in ps where the value is less than 1/n, and highs, containing the indices of elements where the value is greater than or equal to 1/n. Variables l and h store the lengths of lows and highs respectively.

While both l and h are nonzero, decrement l by one and decrement h by one. Let j be lows[l], and let k be highs[h]. Set table[j] to (n*ps[j], k). Update ps[k] by adding ps[j] and subtracting 1/n. If ps[k] is greater than or equal to 1/n, set highs[h] to k and increment h by one. Otherwise, set lows[l] to k and increment l by one.

If h equals zero, set highs to lows and set h to l. If h is greater than one, then for each i from 0 to h−1, set table[highs[i]] to (0.5, highs[(i+1) % h]). If h equals one, let j be highs[0] and let k be (j+1) % n. Let (p, a) be table[k]. If a equals j, set table[k] to (p/2, j) and table[j] to (1−p/2, k). Otherwise, set table[k] to (p, j) and table[j] to (p, a).

Note that the algorithm of FIG. 10 can be extended to generate more than two experts per core by, for example repeating the first splitting segment (for many single-expert elements) and extending the alias representation as previously described.

### VIII. Constructing Token Routing Trees

As previously stated, load-balancing may include converting an expert assignment tree into token routing trees (e.g., converting the expert assignment tree 715 of FIG. 7C into the token routing trees 720 of FIG. 7D). To perform the conversion for a given expert e, the control unit may examine all of the paths that end in e and, for every core c that appears on any of these paths, the control unit may divide the sum of the probabilities of all paths that lead to e via core c by the sum of the probabilities of all paths that lead to e (via any core). For example, referring to the numbers of expert assignment tree 715, the probability of a token for processing by expert 1 being routed to core A is (0.4×0.6)/(0.4×0.6+0.3×0.8)=0.5, and the probability of a token for processing by expert 1 being routed to C is (0.3×0.8)/(0.4×0.6+0.3×0.8)=0.5 (which are the probabilities illustrated in FIG. 7D). In another example, for a token for processing by expert 2, the probability of being routed to core A is (0.4×0.32)/(0.4×0.32+0.3×1.0)≈0.3. Note that the probabilities for experts 3 and 4 are trivial because there is only one routing choice for each (a probability of 1.0 that tokens for expert 3 are routed to core A and 1.0 that tokens for expert 4 are routed to core C). After the probabilities are calculated by a control unit for a given expert, the control unit may construct a corresponding token routing tree for that expert.

### IX. Routing Tokens to Cores

Given a token with selected expert e, a control unit may access (e.g., look up) the token routing tree for e to determine which cores can accept the token (in other words, to determine which cores store the selected expert). Next, the control unit may select one of the determined cores according to the per-core weights (e.g., based on the probabilities specified in the token routing tree) and route that token to the selected core.

Core selection for tokens can be performed in any way that approximates the token-to-core distribution specified by the corresponding token routing tree. For example, a control unit normalizes the weights and uses a random sampling technique (e.g., an alias method or a rejection sampling method) to select a core according to the distribution. In another example, a control unit counts the total number of tokens T to be processed by a given expert and routes ceil(T×pᵢ) tokens to each core i in the distribution (where pi is the probability for core i). In another example, the control unit routes floor(T×pᵢ) tokens to each core i in the distribution and routes the remaining tokens randomly.

To route tokens which select multiple experts (e.g., top_k>1 in MoE parlance), the control unit can replicate each token into top_k copies and assign each copy a different expert for processing. This reduces the problem to the top_k=1 case, and any of the routing techniques described above apply.

### Example Load Balancing Operations

In another example, a machine learning model includes four experts, identified as E1, E2, E3, and E4, executed across two cores, Core A and Core B. The expected incoming workload is heavily imbalanced: approximately 60% of tokens are routed to E1, 20% to E2, and 10% each to E3 and E4. In a naïve expert-to-core mapping, Core A stores E1 and E2 while Core B stores E3 and E4. Under this arrangement, Core A must process approximately 80% of all tokens while Core B processes only about 20%, resulting in significant load imbalance, increased latency, and under-utilization of Core B.

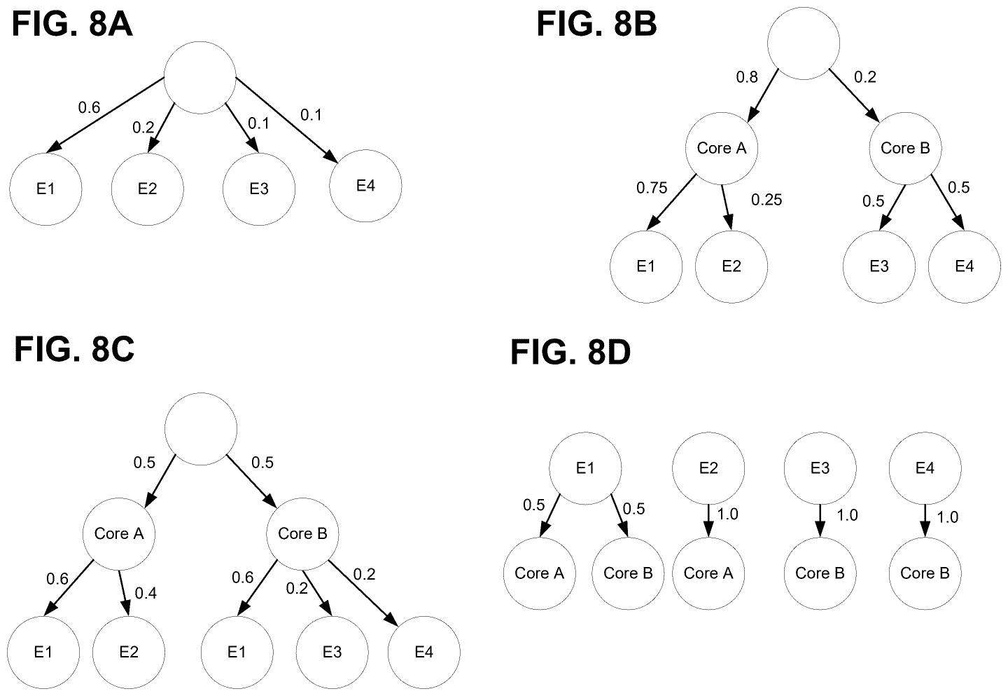

To address this imbalance, a control unit first calculates an expert distribution from the set of tokens, identifying the probability that a token will be routed to each expert. This distribution is expressed as an expert distribution tree, with leaf nodes representing experts and weighted edges indicating the probability that a token will be processed by the corresponding expert (e.g., see FIG. 8A). For the example above, the calculated probabilities are 0.6 for E1, 0.2 for E2, and 0.1 for each of E3 and E4.

The control unit then performs a coarse load-balancing operation augmenting the expert distribution tree with intermediate nodes representing the cores, thereby creating an expert assignment tree (e.g., see FIG. 8C). In this structure, E1 is assigned to both Core A and Core B so that each core processes approximately half of E1's predicted load. In the resulting expert assignment tree, Core A is allocated E1 (30% of the total workload) and E2 (20%), and Core B is allocated E1 (30%), E3 (10%), and E4 (10%). This allocation yields a predicted total workload of approximately 50% for each core, matching their processing capacities. Note that an example expert assignment tree for the naïve mapping (described earlier) is illustrated in FIG. 8B.

Using the expert assignment tree of FIG. 8C, the control unit generates fine-grained token routing tree for runtime use (e.g., see FIG. 8D). For each expert, a token routing tree identifies the cores that store the expert and assigns routing probabilities proportional to the share of the expert allocated to those cores. In this case, tokens for E1 are routed 50% to Core A and 50% to Core B, while E2 tokens are routed entirely to Core A and E3/E4 tokens entirely to Core B.

At runtime, when a token's expert is determined (e.g., by the machine learning model's gating function), the corresponding token routing tree is consulted to select a core with that expert e.g., via random sampling or deterministic allocation. This combination of coarse redistribution of experts and fine-grained probabilistic routing results in balanced utilization: Core A processes E1 (30%) and E2 (20%) for a total of 50%, while Core B processes E1 (30%), E3 (10%), and E4 (10%) for the remaining 50%. The runtime distribution helps ensure that both cores are kept equally busy, reducing or eliminating a processing bottleneck while preserving the benefits of expert parallelism.

### Example Methods for Balancing Workload

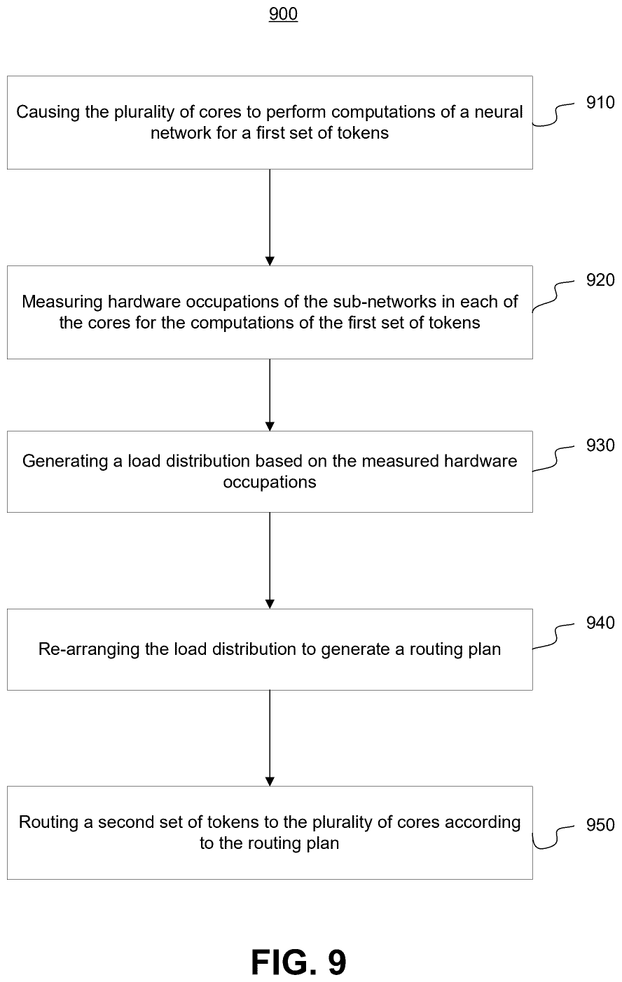

FIG. 9 is a flowchart illustrating an example process 900 for balancing workload of a plurality of artificial intelligence (AI) accelerating computing elements, the AI-accelerating computing elements being integrated circuits, in accordance with some embodiments. In various embodiments, the process 900 may include different, more, or fewer steps. The steps may also be performed in a different order from that illustrated in FIG. 9. In the example of FIG. 9, the steps are performed by a control unit (as previously described), however one or more of the steps may be performed by one or more control units (of a control unit system) and/or one or more other components.

At step 910, the control unit causes the plurality of cores to perform computations of a neural network for a first set of tokens. The neural network comprises a plurality of sub-networks (also referred to as “experts”), and the tokens in the first set are processed by different sub-networks in the neural network.

At step 920, the control unit measures hardware occupancy of the sub-networks in each of the cores for the computations of the first set of tokens. For example, the control unit measures the number of operations (e.g., integer operations, binary operations, or FLOPs (floating point operations)) of each core.

At step 930, the control unit generates a load distribution (e.g., 715) based on the measured hardware occupancy, the load distribution indicating how the plurality of cores are utilized in the computations of the first set of tokens. In some embodiments, steps 910, 920, and/or 930 are not performed and the load distribution is already determined or generated based on another determination. For example, a load distribution (e.g., 715) is provided (e.g., calculated) from an oracle, estimated theoretically, pre-estimated during training, or any combination thereof. In another example, a load distribution is previously determined and an example process for balancing workload includes a control unit accessing the load distribution from a memory.

At step 940, the control unit re-arranges the load distribution to generate a routing plan (e.g., 720). The routing plan determines how a token selected to be processed by one of the sub-networks is routed among the plurality of cores.

At step 950, the control unit routs a second set of tokens (the second set may be the same or a different size as the first set) to the plurality of cores according to the routing plan, where each token in the second set is routed to one or more cores based on the routing plan.

In some embodiments, the plurality of cores are a plurality of cores in AI-accelerating processors, the neural network is a mixture of expert (MoE) model, and the plurality of sub-networks are experts in the MoE model, and wherein routing the second set of tokens to the plurality of cores according to the routing plan includes routing the tokens in the second set to different cores based on core-expert assignments in the routing plan.

Each core may include memory, and the process 900 may additionally include the control unit loading weight values of a particular sub-network to the memory of a particular core based on the routing plan (or the load distribution) that specifies tokens for the particular sub-network is to be routed to the particular core.

Measuring the hardware occupancy of the sub-networks in each of the cores for the computations of the first set of tokens may include the control unit tallying the number of tokens of the first set processed by each of the sub-networks of the plurality of subnetworks.

In some embodiments, the load distribution is a load-distribution tree including leaf nodes representing sub-networks, intermediate nodes representing cores, and edges connecting the nodes. Edges to the intermediate nodes may have weights representing likelihoods of tokens being routed to corresponding cores, and edges to the leaf nodes may have weights representing likelihoods of tokens being processed by corresponding sub-networks.

The process 900 may further include the control unit periodically performing a measurement of distributions of computations of a subsequent set of tokens, and re-generating the routing plan based on the measurement to re-balance workload of the plurality of cores.

In some embodiments, responsive to the control unit determining a memory of a particular core includes weight values of only a single sub-network (or of less than a threshold number of sub-networks that specifies a minimum number of sub-networks per core (e.g., two, three, or four sub-networks)) of the plurality of sub-networks, the control unit loads weight values of another sub-network of the plurality of sub-networks to the memory of the particular core. The control unit may load weight values of multiple other sub-networks of the plurality of sub-networks to the memory of the particular core until the memory of the particular core includes weight values of a number of sub-networks that is equal to or greater than a threshold number of sub-networks). This may be repeated until the memories of all of the cores store at least the threshold number of sub-networks specified by the threshold number.

In some embodiments, responsive to determining the load distribution indicating a core implements less than a threshold number of sub-networks, revising the load distribution to indicate the core implements at least the threshold number of sub-networks of the plurality of sub-networks. Responsive to this, sub-networks may be stored on the cores according to the revised load distribution or the routing plan (which is based on the revised load distribution).

In some embodiments, the control unit routing the second set of tokens to the plurality of cores according to the routing plan includes: for a token selected to be processed by a sub-network stored on two or more cores, the control unit routs the token to one of the two or more cores according to a distribution of the routing plan. For example, the control unit samples a random number and routes the token according to the distribution. In another example, the control unit routes the token based on the number of tokens in the second set previously routed to the one of the two or more cores.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g., method, can be claimed in another claim category, e.g., computer program product, system, device, processor, or storage medium, as well. The dependencies or references in the attached claims are chosen for formal reasons only. However, any subject matter resulting from a deliberate reference back to any previous sections in the specification or claims (in particular multiple dependencies) can be claimed as well, so that any combination of claims, sections in the specifications, and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcodes, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware circuitry or software, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

For one or more components that are configured to perform certain tasks, the components may be parallel components (e.g., one or more processing nodes) and the components may perform the task individually, cooperatively, or in a distributed manner. For example, if one or more processing nodes are to perform a series of steps, unless further specified, the disclosure covers the possibility that one node performs all of the steps, one node performs one step and another node performs another step, or all of the nodes performs all of the steps.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A method for balancing workload of a plurality of artificial intelligence (AI) accelerating cores, the AI-accelerating cores being integrated circuits, the method comprising:
causing the plurality of cores to perform computations of a neural network for a first set of tokens, wherein the neural network comprises a plurality of sub-networks, and the tokens in the first set are processed by different sub-networks in the neural network;
measuring hardware occupancy of the sub-networks in each of the cores for the computations of the first set of tokens;
generating a load distribution based on the measured hardware occupancy, the load distribution indicating how the plurality of cores are utilized in the computations of the first set of tokens;
re-arranging the load distribution to generate a routing plan, the routing plan determining how a token selected to be processed by one of the sub-networks is routed among the plurality of cores; and
routing a second set of tokens (e.g., the second set may be the same or a different size as the first set) to the plurality of cores according to the routing plan, wherein each token in the second set is routed to one or more cores based on the routing plan.

2. The method of claim 1, wherein the plurality of cores are a plurality of cores in AI-accelerating processors, the neural network is a mixture of expert (MoE) model, and the plurality of sub-networks are experts in the MoE model, and wherein routing the second set of tokens to the plurality of cores according to the routing plan comprises routing the tokens in the second set to different cores based on core-expert assignments in the routing plan.

3. The method of claim 1, wherein each core comprises memory, and the method further comprises:
loading weight values of a particular sub-network to the memory of a particular core based on the routing plan that specifies tokens for the particular sub-network is to be routed to the particular core.

4. The method of claim 1, wherein measuring the hardware occupancy of the sub-networks in each of the cores for the computations of the first set of tokens comprises:
tallying the number of tokens of the first set processed by each of the sub-networks of the plurality of subnetworks.

5. The method of claim 1, wherein the load distribution is a load-distribution tree comprising leaf nodes representing sub-networks, intermediate nodes representing cores, and edges connecting the nodes.

6. The method of claim 5, wherein:
edges to the intermediate nodes have weights representing likelihoods of tokens being routed to corresponding cores; and
edges to the leaf nodes have weights representing likelihoods of tokens being processed by corresponding sub-networks.

7. The method of claim 1, further comprising:
periodically performing a measurement of distributions of computations of a subsequent set of tokens; and
re-generating the routing plan based on the measurement to re-balance workload of the plurality of cores.

8. The method of claim 1, further comprising:
responsive to determining a memory of a particular core includes weight values of only a single sub-network of the plurality of sub-networks, loading weight values of another sub-network of the plurality of sub-networks to the memory of the particular core.

9. The method of claim 1, wherein routing the second set of tokens to the plurality of cores according to the routing plan comprises:
for a token selected to be processed by a sub-network stored on two or more cores, routing the token to one of the two or more cores according to a distribution of the routing plan.

10. A system comprising:
a plurality of cores, each implemented as integrated circuit for accelerating artificial intelligence (AI) computations; and
a control unit system for load-balancing the plurality of cores, the control unit system configured to:
cause the plurality of cores to perform computations of a neural network for a first set of tokens, wherein the neural network comprises a plurality of sub-networks, and the tokens in the first set are processed by different sub-networks in the neural network;
measure hardware occupancy of the sub-networks in each of the cores for the computations of the first set of tokens;
generate a load distribution based on the measured hardware occupancy, the load distribution indicating how the plurality of cores are utilized in the computations of the first set of tokens;
re-arrange the load distribution to generate a routing plan, the routing plan determining how a token selected to be processed by one of the sub-networks is routed among the plurality of cores; and
route a second set of tokens (e.g., the second set may be the same or a different size as the first set) to the plurality of cores according to the routing plan, wherein each token in the second set is routed to one or more cores based on the routing plan.

11. The system of claim 10, wherein the neural network is a mixture of expert (MoE) model, and the plurality of sub-networks are experts in the MoE model, and wherein routing the second set of tokens to the plurality of cores according to the routing plan comprises routing the tokens in the second set to different cores based on core-expert assignments in the routing plan.

12. The system of claim 10, wherein each core comprises memory, and the control unit system is further configured to:
load weight values of a particular sub-network to the memory of a particular core based on the routing plan that specifies tokens for the particular sub-network is to be routed to the particular core.

13. The system of claim 10, wherein to measure the hardware occupancy of the sub-networks in each of the cores for the computations of the first set of tokens, the control unit system is configured to:
tally the number of tokens of the first set processed by each of the sub-networks of the plurality of subnetworks.

14. The system of claim 10, wherein the load distribution is a load-distribution tree comprising leaf nodes representing sub-networks, intermediate nodes representing cores, and edges connecting the nodes.

15. The system of claim 14, wherein:
edges to the intermediate nodes have weights representing likelihoods of tokens being routed to corresponding cores; and
edges to the leaf nodes have weights representing likelihoods of tokens being processed by corresponding sub-networks.

16. The system of claim 10, wherein the control unit system is further configured to:
periodically perform a measurement of distributions of computations of a subsequent set of tokens; and
re-generate the routing plan based on the measurement to re-balance workload of the plurality of cores.

17. The system of claim 10, wherein the control unit system is further configured to:
responsive to a determination that a memory of a particular core includes weight values of only a single sub-network of the plurality of sub-networks, load weight values of another sub-network of the plurality of sub-networks to the memory of the particular core.

18. The system of claim 10, wherein to route the second set of tokens to the plurality of cores according to the routing plan, the control unit system is further configured to:
for a token selected to be processed by a sub-network stored on two or more cores, route the token to (e.g., only) one of the two or more cores according to a distribution of the routing plan.

19. A data-center system, comprising:
a plurality of interconnected AI-accelerating cores arranged in one or more server racks; and
one or more host central processing units (CPUs) for load-balancing the plurality of AI-accelerating cores, the host CPUs, when executing a set of load-balancing instructions, are caused to perform:
causing the plurality of cores to perform computations of a neural network for a first set of tokens, wherein the neural network comprises a plurality of sub-networks, and the tokens in the first set are processed by different sub-networks in the neural network;
measuring hardware occupancy of the sub-networks in each of the cores for the computations of the first set of tokens;
generating a load distribution based on the measured hardware occupancy, the load distribution indicating how the plurality of cores are utilized in the computations of the first set of tokens;
re-arranging the load distribution to generate a routing plan, the routing plan determining how a token selected to be processed by one of the sub-networks is routed among the plurality of cores; and
routing a second set of tokens to the plurality of cores according to the routing plan, wherein each token in the second set is routed to one or more cores based on the routing plan.

20. The data-center system of claim 19, wherein the neural network is a mixture of expert (MoE) model and the plurality of sub-networks are experts in the MoE model, and wherein routing the second set of tokens to the plurality of cores according to the routing plan comprises routing the tokens in the second set to different cores based on core-expert assignments in the routing plan.
